(19) United States
(12) Patent Application Publication
(10) Pub. No.: US 2002/0114744 A1
(43) Pub. Date: Aug. 22, 2002

(54) Multimedia and scent storage cartridge design having electrostatic scent release and methods for using same

(76) Inventors: Dah-Shiarn Chiao, Santa Clara, CA (US); Hong-Wen Fang, Taipei (TW); Chien-An Chang, Taoyuan (TW)

Correspondence Address: David M. O'Neill, 333 E. 56th St. 16-L, New York, NY, 10022, US

(21) Appl. No.: 10/043,928

(22) Filed: Jan. 9, 2002

Related U.S. Application Data
(63) Continuation-in-part of application No. 09/713,983, filed on Nov. 16, 2000.

(51) Int. Cl. B01F 3/04

(52) U.S. Cl. 422/124; 261/26

(57) ABSTRACT

The present invention concerns a scent-bearing and multimedia card or disk for use in conjunction with scent recovery and multimedia playback systems. The scent-bearing and multimedia card or disk comprises an encapsulated optical storage disk for storing multimedia information, and an associated scent storage medium for storing at least one scent. The scent-bearing and multimedia card or disk contains digital scent recovery and multimedia playback control information for use by an associated scent recovery/release and multimedia playback system. The digital scent recovery and multimedia control information is used by the multimedia playback and scent release system to coordinate multimedia playback and scent release. Additional embodiments of the present invention comprise electrostatic scent release systems and methods for effectively and efficiently releasing scent stored in the scent- and multimedia-bearing card or disk. Further embodiments of the present invention comprise methods and systems for editing and storing the digital scent recovery and multimedia information so that user-specified scent recovery and multimedia sequences may be created for current use and saved for future use.

### CROSS REFERENCE TO RELATED APPLICATION

This application is a continuation-in-part of a prior U.S. application with Ser. No. 09/713,983, filed on Nov. 16, 2000 and entitled “MULTIMEDIA AND SCENT STORAGE MEDIUM AND PLAYBACK APPARATUS HAVING ELECTROSTATIC SCENT RELEASE”, which is hereby incorporated by reference in its entirety as if filly restated herein.

### FIELD OF THE INVENTION

The present invention concerns multimedia- and scent-bearing media for use in conjunction with multimedia systems having scent-releasing capability, and in particular to new scent-bearing cartridges for use with encapsulated optical media.

### BACKGROUND OF THE INVENTION

The present invention concerns scent storage and release systems that are used to create olfactory sensations in, e.g., aroma therapy. These systems can be used either separately or in combination with multimedia playback systems. When scent storage and release systems are used in combination with multimedia playback systems, an immersive multi-sensory experience can be created. Such multi-sensory experiences are attractive not only for entertainment purposes, but also for therapeutic purposes.

The prior art concerning such scent storage and release systems, particularly with reference to those systems intended for use with current and contemplated multimedia systems, is beset by a number of limitations. In particular, little thought has been given to how a scent storage and release system can be integrated into a visual and/or auditory multimedia playback system.

This is true on two counts. First, users of such systems will have certain expectations about how such systems should operate due to their experience with multimedia devices, e.g., DVD players, VCRs, portable music devices, and computer-based MP3 music software packages.

The best of these systems give users a high degree of control over the multimedia experience through playback control features. With these systems the user can customize music or multimedia playback sequences and store them for future use. This provides for a desirable customized and repeatable multimedia experience.

In contrast, scent storage and release systems that may be used in combination with multimedia sources show no appreciation of this desirable feature. For example, U.S. Pat. No. 6,282,458 B1 to Murayama et al. describes methods for controlling the creation of olfactory stimuli. Although it suggests that its methods may be used in combination with a multimedia source, there is no description about how this can be accomplished. In particular, there is no description of how scent release and multimedia playback sequences can be combined in a coordinated manner. Further, there is no description of how favorite scent release and multimedia playback sequences can be stored so that they can be retrieved for future use in repeating the scent release and multimedia playback combination.

A second problem concerns the physical integration of scent storage and release systems with known or contemplated multimedia playback systems. This concerns both scent recovery and release systems for use in recovering and releasing scents stored in the scent storage media, and the scent storage media itself. There is little or no appreciation of the need to design scent storage media so that they can be easily combined with multimedia storage media either in an integrated package, or in separate, but combinable, packages.

In particular, there are well-known current and contemplated multimedia storage formats. For example, there is the encapsulated Type II DVD RAM cassette format in which an optical DVD storage media is encapsulated in a rugged housing. There are also the standard DVD and CD optical disk formats. There has been little or no effort made in seeking to integrate scent storage media with these well-known multimedia storage formats. Such an heretofore unknown combination would provide a user with a compact and easy-to-use multimedia and scent storage medium that would be capable in combination with a scent release and multimedia playback system of creating a complete multimedia experience.

There also is a lack of appreciation of the need to design scent release technologies that can be used in close proximity to sensitive electronic equipment. Scents often are volatile oil-like substances that unless properly handled can hinder the fault-free operation of a scent recovery and multimedia playback system.

The prior art reveals numerous other problems associated with current scent storage and release technologies. In particular, one market for such technology is the fragrance industry. Fragrance manufacturers are particularly sensitive concerning the distinctive scent of their fragrances, and desire scent storage and release technologies that preserve the distinctive smell of their products. Current scent-release technologies are frequently heat-based. It is well-known that heat can have a significant negative impact on the chemical composition of a fragrance. Thus, upon release, the distinctive scent of a fragrance can be corrupted by heat, thereby giving the user an inaccurate and possibly unpleasant impression of a fragrance.

Improved scent release technologies are therefore desired. Suitable hardware for applying appropriate scent release technologies, e.g., electrostatic scent release, have not been developed heretofore. These scent release technologies must be designed to operate in conjunction with current and contemplated optical storage technologies in order to take advantage of the large installed technology base associated with such information storage technologies. Presently, there are no known designs suitable for combining electrostatic scent release with optical storage technology. Problems associated with supplying the electric potential necessary for creating the corona discharge used in electrostatic scent release operations have not been addressed.

Another problem concerns the efficient storage and release of scents, fragrances, flavors and aromas so that the minimum amount of these often expensive compounds can be used to maximum effect. One aspect of this problem concerns the efficient storage of scent between scent release operations so that the characteristic smell or scent of the substance is preserved. In addition, as these compounds often are volatile, they will escape over time unless retained in an effective manner.

From the user's perspective, a number of limitations have been identified in current scent release technologies intended for use with multimedia playback systems. In particular, current scent release systems make no provision for allowing a user to create user-specified scent release and multimedia playback sequences, and to save them for future use. In the multimedia field, users have been given a high degree of control over multimedia playback. Users do not have this level of control over scent recovery sequences intended to coincide with multimedia playback.

Thus, those familiar with the prior art desire several heretofore unknown and uncontemplated systems and methods to resolve the current limitations in the prior art. In particular, those skilled in the art desire a scent cartridge design incorporating scent release units that can be easily combined with current and contemplated optical and solid-state information storage technologies. In particular, the most desirable scent cartridge design should be easily integrated into Type II DVD RAM-like cassettes. Such a scent cartridge design could be easily integrated into the housing of the Type II cassette, providing for a single, easy-to-use scent- and multimedia bearing medium. In combination with a scent recovery/release and multimedia playback system, such scent-bearing cartridges and Type II cassettes would be capable of creating immersive multimedia experiences, including visual, audio and olfactory elements.

Those skilled in the art also desire a scent cartridge design that can be easily integrated into known optical and solid-state playback systems. This would eliminate the need to develop special information retrieval technologies for use with scent recovery/release systems. Such a design, when used in combination with current and contemplated optical and solid-state playback systems, would provide new features concerning scent recovery and multimedia playback. The design would allow a user to create user-specified scent recovery and multimedia playback sequences, and to store them for future use.

Those skilled in the art also desire new scent release technologies that improve the performance of scent release systems intended for use in multimedia environments. Particularly desirable are systems that preserve the inherent scent characteristics of the fragrance, aroma or flavor to be released, and in no way degrade them as part of the scent release process. Also desired are scent release operations that heighten the impact of the scent or fragrance by concentrating the scent or fragrance, so that a user experiences a heightened, improved olfactory sensation. The desired scent release technology also would efficiently store the fragrance, aroma or flavor between release operations, thereby reducing the need to replace the scent cartridge due to the evaporation of scent.

Also desired is a scent release unit design that can be integrated into a multimedia playback unit (for example, a DVD player) without negatively impacting in any way the operation of the optical playback unit. The design would resolve a number of issues associated with supplying the necessary electrical and/or light energy used in the scent release operation, without necessitating the need for an overall redesign of the optical playback system. The desired design also would have similar reliability to the optical playback system with a long mean time between failure, making the unit suitable for use in consumer and professional applications.

Those skilled in the art also desire a system that provides a high degree of control over scent recovery and multimedia playback, so that they coincide to create a seamless multimedia experience, and provide similar levels of functionality encountered in other multimedia applications (for example, music and DVD movies). The desired system would permit the user to treat the prerecorded scent recovery and multimedia playback sequences as “raw material” to be modified in accordance with the user's desires to create a user-specified scent recovery and multimedia playback sequence. The system would provide an easy-to-use editing system that can access and retrieve prerecorded scent recovery and multimedia sequences, permit a user to modify them using an interactive and intuitive editing protocol, and then save the newly-created sequence in a non-volatile storage medium for retrieval at a future time.

In summary, those skilled in the art desire a scent cartridge design that is as easy-to-use, inexpensive, rugged and effective as other powerful multimedia technologies.

### SUMMARY OF THE INVENTION

The limitations of the prior art are overcome in embodiments of the present invention. A first preferred embodiment of the present invention comprises a scent- and multimedia-bearing card or disk. The scent- and multimedia-bearing card further comprises a scent storage medium and a multimedia storage medium. The scent storage medium comprises a scent storage unit and scent release unit. The scent release unit comprises a scent release chamber; an electrostatic scent release apparatus; and capillary tubes connecting the scent storage unit to the scent release unit. In one variant of the first preferred embodiment, the multimedia storage medium comprises an encapsulated and removable optical media. The scent- and multimedia-bearing card further comprises a machine-readable memory that may take the form of, for example, flash memory or other solid-state storage technologies. The machine-readable memory stores scent identification information for identifying the scent stored in the scent- and multimedia-bearing card.

The scent- and multimedia-bearing card of the first preferred embodiment and scent cards/disks made in accordance with other preferred embodiments of the present invention can store and release scents, fragrances, aromas and flavors, or any other substance capable of creating olfactory or taste sensations. In addition, the scent- and multimedia-bearing card and disks of the preferred embodiments of the present invention can store and release therapeutic agents and medicines.

A second preferred embodiment of the present invention comprises a specific structure for a scent-bearing medium for use in a scent- and multimedia-bearing card. The structure of the scent-bearing medium comprises a physical configuration that can be easily attached to or integrated with an encapsulated optical multimedia storage device like a Type II DVD-RAM cassette. The scent card has a rectangular housing configuration that shares the same width and depth as the Type II housing. In one variant of the second preferred embodiment, the scent card housing and Type II cassette are integrated as a single unit. In another variant the Type II cassette and scent card housing have snap attachment points so they can be snapped together to form a single unit.

The scent card of the second preferred embodiment comprises at least one scent storage unit and at least one scent release unit. In one variant of the second preferred embodiment, the scent storage unit comprises a scent reservoir and a capillary tube connecting the scent reservoir to the scent release unit. In another variant of the second embodiment, the scent storage unit comprises an absorbent material containing scent that surrounds the scent release unit. The scent release unit comprises a scent release plenum and cover. The plenum is a three-dimensional depression in the housing of the scent card that has an opening at the bottom and an opening at the top. The opening at the bottom is connected to the scent storage unit, and the opening at the top permits scent to escape during scent release operations. The cover encloses the scent release plenum between scent-release operations, and thereby prevents scent from escaping from the scent- and multimedia bearing card.

In another variant of the second preferred embodiment, the cover is made of magnetic material. In this particular variant of the second embodiment, the scent release unit further comprises a magnetic cover opening apparatus for moving the magnetic cover to an open position during scent release operations. The magnetic cover is hingedly connected to the scent card housing. The hinged connection also comprises a spring that returns the magnetic cover to a closed position following the completion of a scent release operation. When the magnetic over is open, scent in the scent release plenum escapes from the scent card into an air flow created adjacent to the scent card during scent release operations.

In a further variant of the second preferred embodiment, the scent release unit further comprises an electrostatic scent release means. The electrostatic scent release means comprises an electrostatic or corona discharge needle, an electrostatic grid and associated wiring. The electrostatic discharge needle is positioned within the scent release plenum, and during scent release operations, ionizes scent contained within the plenum. The ionized scent is attracted to the electrostatic grid, thereby improving evaporation of scent.

A third preferred embodiment of the present invention comprises methods for using a scent-bearing card along with a Type II DVD cassette to create an immersive multimedia experience having visual, sound and olfactory elements. The method uses an associated scent recovery/release and multimedia playback system to release scent from the scent-bearing card and to recover multimedia information from the Type II cassette. The method comprises the following steps: receiving an input command from a user to initiate scent release and multimedia playback; recovering digital scent release and multimedia playback control information corresponding to the user input command from the Type II cassette; initiating multimedia recovery and playback from the Type II cassette corresponding to the multimedia segment selected by the user; interpreting the identity, time, and duration of scent release reflected in the digital scent release and multimedia playback control information; and releasing the proper scents at the proper time and for the proper duration from the scent card. In one variant of the third preferred embodiment, an additional step in which scent to be released is ionized occurs. In another variant of the method of the third preferred embodiment, several scents may be released simultaneously for similar or differing durations. In further variants, an additional step comprising a scent neutralizing operation is added to the method. During the scent neutralizing step, a scent neutralizing agent is released. In one variant the scent neutralizing agent comprises ozone. This step would follow the release of one scent and precede the release of another.

A fourth preferred embodiment of the present invention comprises an integrated scent release and multimedia playback system for use in conjunction with the preceding embodiments, and in particular scent- and multimedia-bearing cards where the multimedia storage medium comprises an encapsulated optical multimedia storage device like a Type II DVD-RAM cassette. The integrated scent release and multimedia playback system further comprises a remote multimedia input means for receiving remote multimedia input signals; a scent release and multimedia playback editing means for editing scent release and multimedia playback sequences, and a recording means for recording the user-created scent release and multimedia playback sequence information to rewritable media like, for example, rewritable optical storage devices or rewritable solid state storage devices.

A fifth preferred embodiment of the present invention comprises a scent- and multimedia-bearing disk having electrostatic scent release. The scent- and multimedia-bearing disk of the fifth embodiment comprises at least two portions, a scent-bearing portion and a multimedia-bearing portion. In one variant of the fifth preferred embodiment, the scent-bearing portion of the disk is divided into separate scent-bearing regions, each for storing a separate scent. The separate scent-bearing regions are in the form of arcs and are arrayed about the outer portion of the disk. The scent-bearing regions are generally enclosed structures except for a first opening to allow scent to escape during scent release operations, and a second opening for wiring used to support scent release.

In one variant of the fifth embodiment, the scent stored in the individual scent storage regions is retained in individual scent reservoirs. In another variant, scent is retained in an absorbent material. In both variants of the fifth embodiment, each scent-bearing region has a separate electrostatic scent release unit for releasing scent stored in the scent-bearing region. The electrostatic scent release unit comprises an electrostatic discharge needle for ionizing scent, fragrance, aroma or flavor stored in the individual scent-bearing regions, and electrostatic wiring for supplying electric potential to the electrostatic discharge needle. The individual scent-bearing regions also have a scent release means for retaining the scent in the scent-storing regions until the initiation of scent release operations. In another variant of the fifth embodiment, the scent release means comprises a semi-permeable membrane that permits ionized scent to pass during scent release operations. In a further variant, the scent release means comprises single release valves. In this variant, the single release valves permit gas flow in only one direction, i.e., they permit released scent to escape, and prevent atmospheric gases from entering the scent-storing regions.

A sixth preferred embodiment of the present invention comprises methods for using a scent- and multimedia-bearing disk having electrostatic scent release. The method uses an associated scent recovery/release and multimedia playback system to release scent and recover multimedia information from the scent- and multimedia-bearing disk. The method comprises the following steps: receiving an input command from a user to initiate scent release and multimedia playback; recovering digital scent release and multimedia playback control information corresponding to the user input command from the scent- and multimedia-bearing disk; initiating multimedia recovery and playback corresponding to the multimedia segment selected by the user; interpreting the identity, time, and duration of scent release reflected in the digital scent release and multimedia playback control information; releasing the proper scents at the proper time and for the proper duration from the scent- and multimedia-bearing disk using electrostatic scent release. In variants of the method of the sixth preferred embodiment, several scents may be released simultaneously for similar, or differing durations. In other variants, an additional step comprising a scent neutralizing operation is added to the method. During the scent neutralizing step, a scent neutralizing agent, for example, ozone would be released. This particular step would follow the release of one scent and precede the release of another.

A seventh preferred embodiment of the present invention comprises an electrostatic scent storage and release unit for use in scent- and multimedia-bearing disks and cards. The electrostatic scent storage and release unit comprises a scent storage reservoir; a scent release plenum; and a capillary tube connecting the scent storage reservoir to the scent release plenum. The scent storage and release unit further comprises a piezoelectric vibrator that vibrates the capillary tube during scent release operations to improve the flow of scent from the scent storage reservoir to the scent release plenum. Located in the scent release plenum is an electrostatic discharge needle. The electrostatic discharge needle ionizes scent in the scent release plenum to improve the efficiency of scent release operations. In variants of the seventh preferred embodiments, the scent release unit further comprises an electrostatic grid for attracting ionized scent molecules.

An eighth preferred embodiment of the present invention comprises a method for using the electrostatic scent storage and release unit of the seventh preferred embodiment. The method comprises the following steps: permitting scent to flow from the scent storage reservoir to the scent release plenum; vibrating the piezoelectric vibrator to improve scent flow from the scent storage reservoir to the scent release plenum; and releasing scent from the scent release plenum. A variant of the eighth preferred embodiment comprises the additional step of ionizing the scent to be released using electrostatic discharge apparatus to improve the efficiency of scent release.

A ninth preferred embodiment of the present invention comprises, in part, the combination of an electrostatic top supply module and a scent- and multimedia-bearing disk having an electrostatic scent release means. The electrostatic top supply module comprises an electric interface for supplying electric potential to the electrostatic scent release means of the scent- and multimedia-bearing disk. The electrostatic top supply module is designed to supply electric potential to the electrostatic scent release means of the scent- and multimedia-bearing card while the disk is rotating. This allows for the simultaneous release of multiple scents from the scent-bearing portion of the disk, and recovery of multimedia information from the multimedia-bearing portion of the disk. The ninth preferred embodiment further comprises a scent- and multimedia-bearing disk. The disk is in the form of a conventional optical disk (e.g., DVD or CD) on one side, and has a scent-bearing region on the other side. The scent-bearing portion of the disk has multiple scent-storing regions for storing different scents.

The scent-bearing portion of the disk further comprises an electrostatic scent release means. The electrostatic scent release means comprises electrostatic discharge needles and electrostatic wiring for supplying electric potential to the electrostatic discharge needles. The electrostatic scent release means allows for the separate and simultaneous release of scents from the different scent storage regions of the disk. The electrostatic top supply module comprises a housing that is mounted on top of the scent-bearing portion of the scent- and multimedia-bearing disk. The housing has a plurality of wires for supplying electric potential to the electrostatic wiring of the disk.

In one variant of the ninth embodiment, the electric potential is supplied to the electrostatic wiring through metallic balls. The metallic balls maintain the wiring of the electrostatic top supply module in contact with the electrostatic wiring as the disk rotates. The metallic balls are maintained in place by springs. There is a metallic ball/spring assembly for each scent storage region. This permits the separate or simultaneous release of scents from the scent-bearing portion of the disk. In another variant of the ninth preferred embodiment, the individual scent storage regions are separately removable and replaceable from the other scent storage regions. This means that when the scent from one scent storage region is exhausted, the user only has to replace that scent storage region, and not the entire disk.

A tenth preferred embodiment of the present invention comprises a scent- and multimedia-bearing disk having microencapsulated scent embedded in the scent-bearing portion of the scent- and multimedia-bearing disk. The microencapsulated scent is released from the scent-bearing portion of the disk during a scent-release operation by light energy delivered by a laser. In variants of the tenth preferred embodiment, the scent-bearing region can store either single scents or multiple scents. In the case of multiple scents, the scents would be stored in concentric rings. In variants of the tenth preferred embodiment, the concentric rings would be individually removable and replaceable, meaning that a user would only have to replace portions of the scent- and multimedia-bearing disk, and not the entire disk.

An eleventh preferred embodiment of the present invention comprises method and apparatus for monitoring the release and utilization of scent from scent- and multimedia-bearing disks made in accordance with the other preferred embodiments of the present invention described herein. In particular, the apparatus of the eleventh preferred embodiment comprises a scent utilization means for monitoring the utilization of scent; a scent remaining calculation means for informing the user of the amount of scent remaining in a scent- and multimedia-bearing disk; and a depletion prediction means for predicting when a scent- and multimedia-bearing disk will need to be replaced due to the depletion of scent. The scent utilization means identifies which scent is being released during a scent release operation; monitors the strength and duration of scent release; and records the same information for each subsequent release of the same scent. The scent remaining calculation means uses the scent utilization information to calculate the amount of scent remaining. The scent depletion prediction means also uses the scent utilization information, but uses it to make a prediction based on current consumption patterns of when the scent will be depleted.

The method of the eleventh preferred embodiment comprises the following steps: identifying the scent being released during a scent release operation; recording the scent release event in a scent release event file and storing the file in a non-volatile memory medium; monitoring the duration of scent release; recording the duration of scent release in the scent release event file; monitoring the strength of scent release during a scent release operation; recording the strength of scent release in the scent release event file; and repeating the preceding steps for each subsequent scent release. One variant of the eleventh preferred embodiment comprises the step of calculating the scent remaining by retrieving all the scent release event files for a particular scent; calculating the amount of scent released during the scent release events; and subtracting this amount from the starting scent amount. Another variant comprises the step of predicting scent depletion time by retrieving all the scent release files for a particular scent; calculating the amount of scent released during scent release events; calculating the scent release rate from the data; determining the amount of scent remaining by subtracting the amount of scent released from the starting amount; and dividing the scent remaining by the scent release rate.

The apparatus and method of the eleventh preferred embodiment are particularly useful in combination with scent- and multimedia-bearing disks having individually replaceable scent storage and release units. The eleventh embodiment will permit the user to monitor the varying utilization of differing scents and to make purchasing and stocking decisions based on this information. The user will stock scents that are rapidly depleted, and will delay purchase of scents that are not used that frequently. This permits the highly efficient utilization of the scent- and multimedia-bearing disk.

A twelfth preferred embodiment of the present invention comprises apparatus and method for permitting a user to create time-line based scent release and multimedia playback sequences. The apparatus of the twelfth embodiment comprises a scent release and multimedia playback system having a time-line editing means. The time line scent release and multimedia editing means comprises a visual display and audio playback means for displaying or playing multimedia information; a timeline display means for displaying a timeline that coincides with the playback of the multimedia information; scent release addition means for adding scent release events to the multimedia timeline; and scent release and multimedia playback information recording means for recording the user-created scent release and multimedia playback timeline in a volatile or non-volatile memory medium for retrieval at a future time.

The method of the twelfth embodiment comprises the following steps: creating a timeline corresponding to a multimedia playback sequence; adding scent release events to the timeline, wherein the scent release event information comprises scent identity; scent release start time; and scent release end time; and saving the scent release and multimedia playback timeline in a memory medium for future retrieval in controlling a scent release and multimedia playback sequence. A variant of the method of the twelfth embodiment includes the additional step of adding multiple overlapping scent release events to the scent release and multimedia playback timeline.

A thirteenth embodiment of the present invention comprises a multimedia playback goggle and an electrostatic scent release mask for releasing scent directly to the nose and/or mouth of a user. The multimedia goggle comprises a nose-bridge-mounted display screen placed directly in front of the eyes of the user to display multimedia information, and earphones to play back audio information. The electrostatic scent release mask comprises at least two scent storage units and at least two scent release units. At least one scent storage unit and at least one scent release unit is positioned adjacent to the nose, to supply scent, fragrances or aromas to the user's nose. At least one scent storage unit and at least one scent release unit is positioned adjacent to the mouth to supply flavors to the user's mouth. Electrostatic scent release units comprise at least an electrostatic discharge needle and associated wiring for ionizing scent, fragrance, aroma or flavor. Electrostatic scent release units included in variants of the thirteenth embodiment further comprise electrostatic grids for attracting ionized scent molecules to improve efficiency of scent released. Variants of the thirteenth embodiment delete the grid to accomplish different system objectives, for example, to permit ionized scent molecules to be attracted to the body of a user.

One of ordinary skill in the art will understand that each of the alternate embodiments can be practiced either singly, in combination, or in combination with other scent release and multimedia playback systems. In addition, one of ordinary skill in the art will understand that the preceding alternate embodiments can be combined in various ways to accomplish different system objectives. Further, one of ordinary skill in the art will understand that the means of accomplishing the functionality described herein can be distributed in various ways, e.g., combined into a single stand-alone system or distributed among a plurality of separate, but interconnected and communicating, systems. All of these variants are within the scope of the present invention.

Thus it is seen that the multimedia and scent storage cartridge design having electrostatic scent release overcomes the limitations of the prior art. For example, the scent storage design provides a rugged and easily-integrated unit that can be used in combination with Type II DVD RAM cartridges. The scent cartridge design takes advantage of an existing optical storage format design and provides a scent release capability. The scent cartridge design will also permit designers to add scent release capability to existing multimedia playback systems.

The present invention also provides an electrostatic scent release system for use in combination with the scent cartridge. The electrostatic scent release system of the present invention provides for efficient and effective scent release that creates a pleasing olfactory sensation for users with a minimum of expensive fragrance, scent, aroma and/or flavor. The present invention also preserves the natural smell of the to-be-released scent, fragrance, scent and/or flavor, and avoids the undesirable degradation encountered in prior art systems, particularly scent release systems employing thermal scent release technologies. The laser-based scent release system of the present invention also achieves these desirable objectives.

The present invention further provides an effective and efficient design for the scent storage/release cartridge. The scent release unit uses a spring-loaded and electromagnetic system for tightly shutting the scent release unit between scent release operations, thereby avoiding the escape of volatile scent, fragrance, aroma and/or flavor stored in the cartridge. The electromagnetic scent release system can be precisely controlled to release scent at the desired time.

### BRIEF DESCRIPTION OF THE FIGURES

The above and other objects and advantages of this invention will be apparent upon consideration of the following detailed description, taken in conjunction with the accompanying drawings in which like characters refer to like elements throughout and in which:

FIG. 1 depicts side, top and perspective views of a Type II DVD cassette—scent card made in accordance with first and second preferred embodiments of the present invention;

FIGS. 2A-F depict perspective views of alternate scent-bearing card—Type II DVD cassette configurations made in accordance with the first and second preferred embodiments of the present invention;

FIG. 3 depicts a top view of an open Type II DVD cassette;

FIG. 4 depicts side, top and perspective views of a scent- or flavor-bearing card attached to the door of a Type II DVD cassette made in accordance with the second preferred embodiment of the present invention;

FIG. 5 depicts side, top and perspective views of a scent- or flavor-bearing card having capillary tubing made in accordance with the second preferred embodiment of the present invention;

FIG. 6 depicts side, top and perspective views of a scent- or flavor-bearing card with a data storage medium (e.g., SIM card, flash memory, memory chip) and a scent release unit made in accordance with the second preferred embodiment of the present invention;

FIG. 7 depicts side, top and perspective views of a scent- or flavor-bearing card with an electrical interface made in accordance with the second preferred embodiment of the present invention;

FIG. 8 depicts side, top and perspective views of a scent- or flavor-bearing card with tagging information (e.g., text, image, icon or bar code) on the surface made in accordance with the second preferred embodiment of the present invention;

FIG. 9 depicts partially exploded views of an electrostatic and electromagnetic module made in accordance with the second preferred embodiment of the present invention;

FIG. 10 comprises a block diagram depicting the operation of the electrostatic and electromagnetic modules operating in accordance with the second preferred embodiment of the present invention;

FIG. 11 depicts the construction of the electrostatic and electromagnetic modules of the second preferred embodiment of the present invention;

FIG. 12 depicts the construction of the electrostatic and electromagnetic modules of the second preferred embodiment of the present invention;

FIG. 13 depicts in schematic form the operation of the pin-type scent releasing unit in accordance with a preferred embodiment of the present invention;

FIG. 14 comprises a block diagram depicting the operation of a scent- and multimedia-bearing disk operating in accordance with a method of a sixth preferred embodiment of the present invention;

FIGS. 15A-C depict in cross-sectional views electrostatic scent- or flavor-releasing units constructed in accordance with a fifth preferred embodiment of the present invention;

FIG. 16 depicts in schematic form the operation of electrostatic scent- or flavor-releasing unit operating in accordance with the sixth preferred embodiment of the present invention;

FIG. 17 depicts top and perspective views of a scent- and multimedia-bearing disk having an electrostatic scent release unit constructed in accordance with the fifth preferred embodiment of the present invention;

FIG. 18 depicts top and perspective views of an alternate scent- and multimedia-bearing disk having an electrostatic scent- or flavor-releasing unit made in accordance with the fifth preferred embodiment of the present invention;

FIG. 19 depicts a cross-sectional view of an alternate scent- and multimedia-bearing card having an electrostatic scent- or flavor-releasing unit made in accordance with the fifth preferred embodiment of the present invention;

FIG. 20 depicts a see-through perspective view of an alternate scent- and multimedia-bearing card having an electrostatic scent- or flavor-releasing unit made in accordance with the fifth preferred embodiment of the present invention;

FIG. 21 comprises a block diagram depicting the operation of a piezoelectric scent releasing unit operating in accordance with the method of the eighth preferred embodiment of the present invention;

FIG. 22 comprises a block diagram depicting the operation of a piezoelectric flavor releasing unit operating in accordance with the method of the eighth preferred embodiment of the present invention;

FIG. 23 depicts in cross-sectional view a piezoelectric and electrostatic scent- or flavor-releasing unit constructed in accordance with a seventh preferred embodiment of the present invention;

FIG. 24 depicts in cross-sectional view a scent- or flavor-releasing unit having an ionization nozzle head made in accordance with a seventh preferred embodiment of the present invention;

FIG. 25 comprises a block diagram depicting the operation of a scent-bearing disk having an electrostatic top supply module operating in accordance with a ninth preferred embodiment of the present invention;

FIG. 26 depicts an exploded view of a scent disk made having an electrostatic top supply module constructed in accordance with the ninth preferred embodiment of the present invention;

FIG. 27 depicts top, side and perspective views of an electrostatic scent- and multimedia-bearing disk having an electrostatic top supply module constructed in accordance with the ninth preferred embodiment of the present invention;

FIG. 28 depicts top, side and perspective see-through views of an electrostatic top supply module made in accordance with the ninth preferred embodiment of the present invention;

FIG. 29 depicts a wiring schematic for a scent disk made in accordance with the ninth preferred embodiment of the present invention;

FIG. 30 depicts an alternate scent disk made in accordance with the ninth preferred embodiment of the present invention;

FIG. 31 depicts an alternate scent disk made in accordance with the ninth preferred embodiment of the present invention;

FIG. 32 comprises a block diagram depicting the operation of microencapsulated scent disk operating in accordance with a method of a tenth preferred embodiment of the present invention;

FIG. 33 depicts top and perspective views of a microencapsulated scent disk constructed in accordance with the tenth preferred embodiment of the present invention;

FIG. 34 depicts a block diagram showing monitoring and recording of scent utilization data during a scent release sequence in accordance with a method of an eleventh preferred embodiment of the present invention;

FIG. 35 comprises a block diagram depicting the editing and updating of scent recovery and multimedia playback control information in accordance with the method of the twelfth preferred embodiment of the present invention;

FIG. 36 depicts in schematic form the editing and updating of a scent recovery sequence in accordance with the twelfth preferred embodiment of the present invention; and

FIG. 37 depicts a scent- and flavor-capable multimedia goggle and mask made in accordance with a thirteenth preferred embodiment of the present invention.

### DETAILED DESCRIPTION OF THE PREFERRED EMBODIMENTS

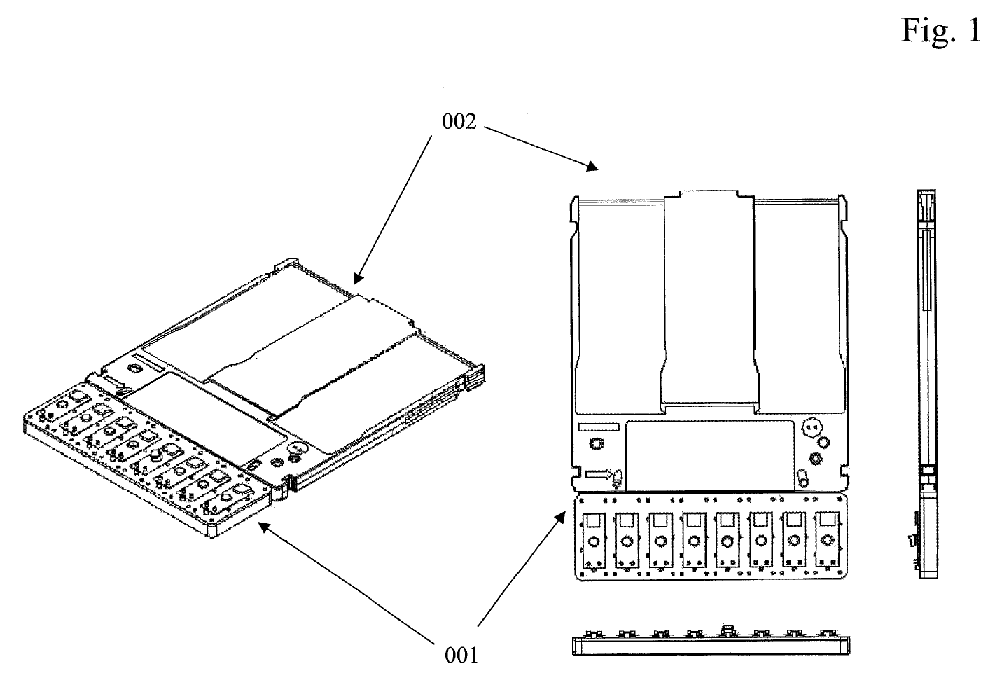

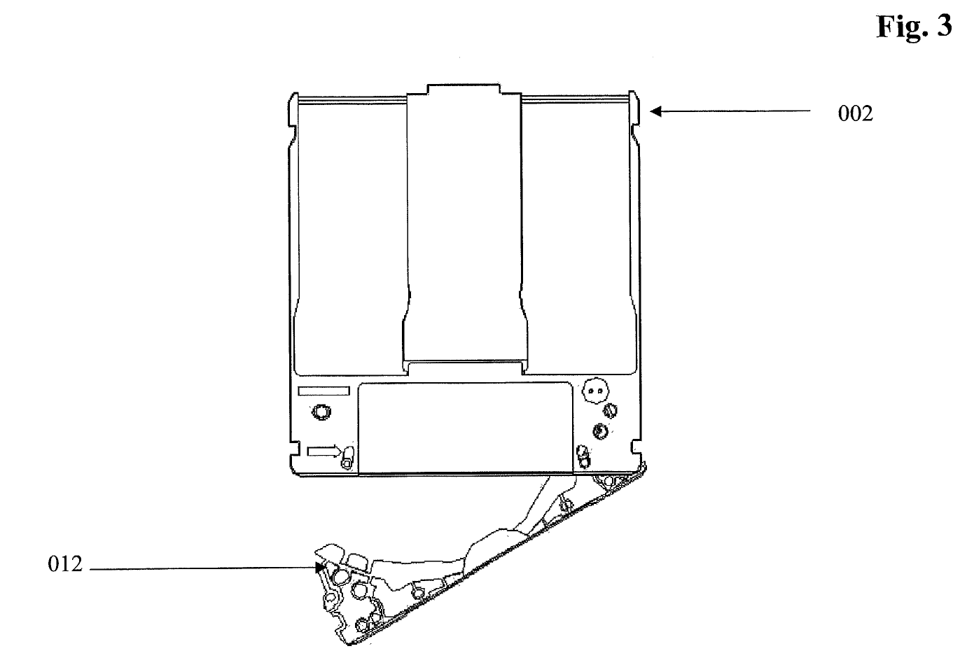

A scent card made in accordance with a first preferred embodiment of the present invention is depicted in perspective, top and side views in FIG. 1. The scent card 001 is depicted attached to a Type II DVD-RAM cassette encapsulating an optical storage medium. The Type II DVD-RAM cassette is shown to better advantage in FIG. 3, which depicts the slot cover 12 of the Type II DVD-RAM cassette open so the optical disk can be removed or reinserted. In variants of the present invention, the encapsulated optical storage media can take the form of DVD-RAM and other known and contemplated DVD storage formats, for example DVD-R, DVD-RW, DVD+RW, etc.

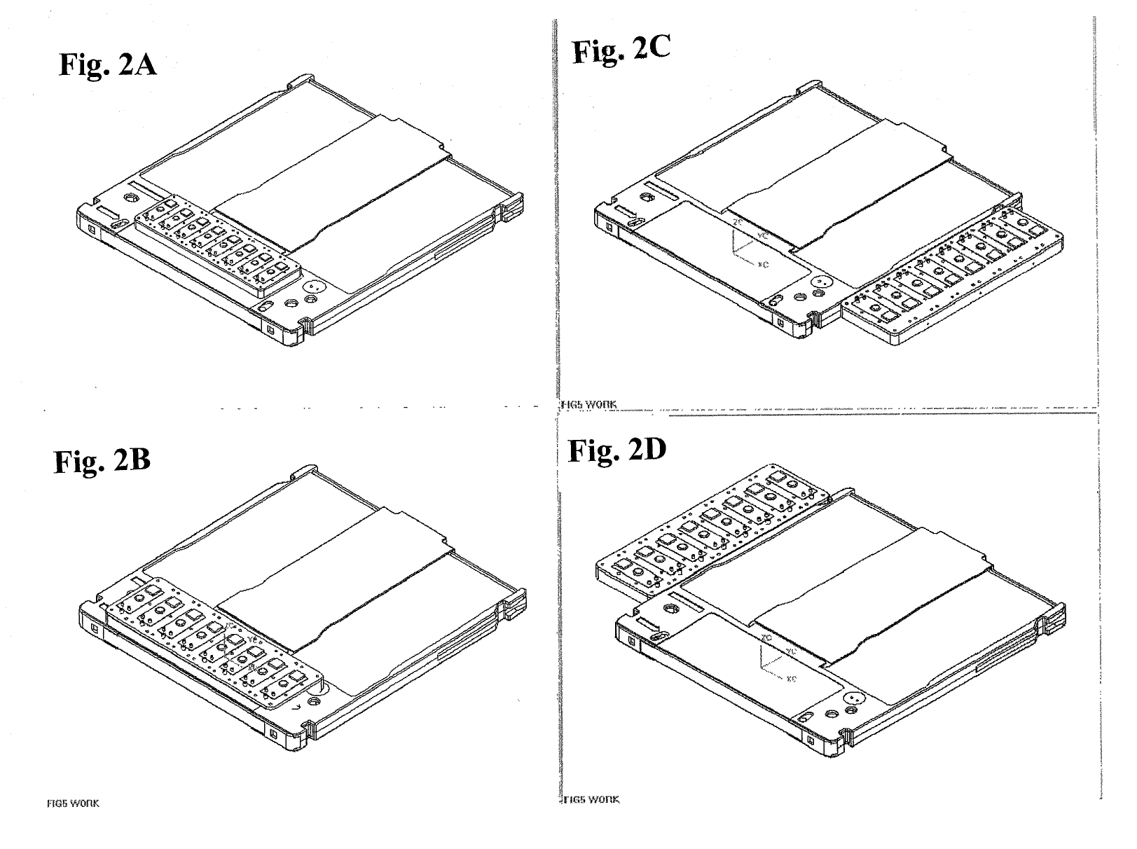

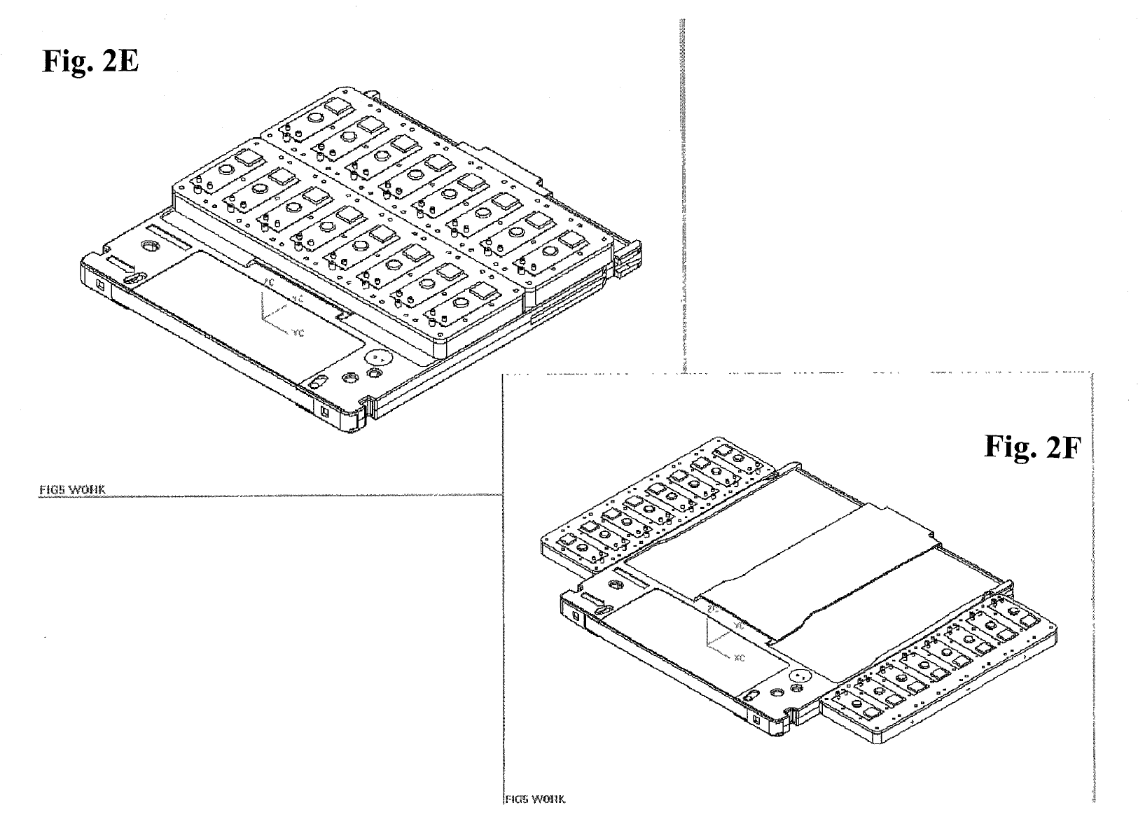

FIGS. 2A-F depict variants of the first preferred embodiment in which scent cards 001 are combined in various ways about the periphery of the Type II DVD-RAM cassette. In FIGS. 2E-F two scent cards are combined with a single Type II DVD-RAM cassette to provide more scent or fragrance alternatives.

Before proceeding with further description of the preferred embodiments of the present invention, the inventors state that the term “scent” as used in this document refers generically to scents, fragrances, smells, aromas and flavors and any and all substances capable of creating olfactory and/or taste sensations. Further, as stated previously, the scent- and multimedia-bearing card of the first preferred embodiment and scent cards made in accordance with other preferred embodiments of the present invention are capable of storing and releasing scents, fragrances, aromas and flavors, or any other substance capable of creating olfactory and/or taste sensations. In addition, the scent- and multimedia- bearing card and disks of the preferred embodiments of the present invention are capable of storing and releasing therapeutic agents and medicines. Finally, the preferred embodiments of the present invention can work with scents in other than liquid form, for example gels.

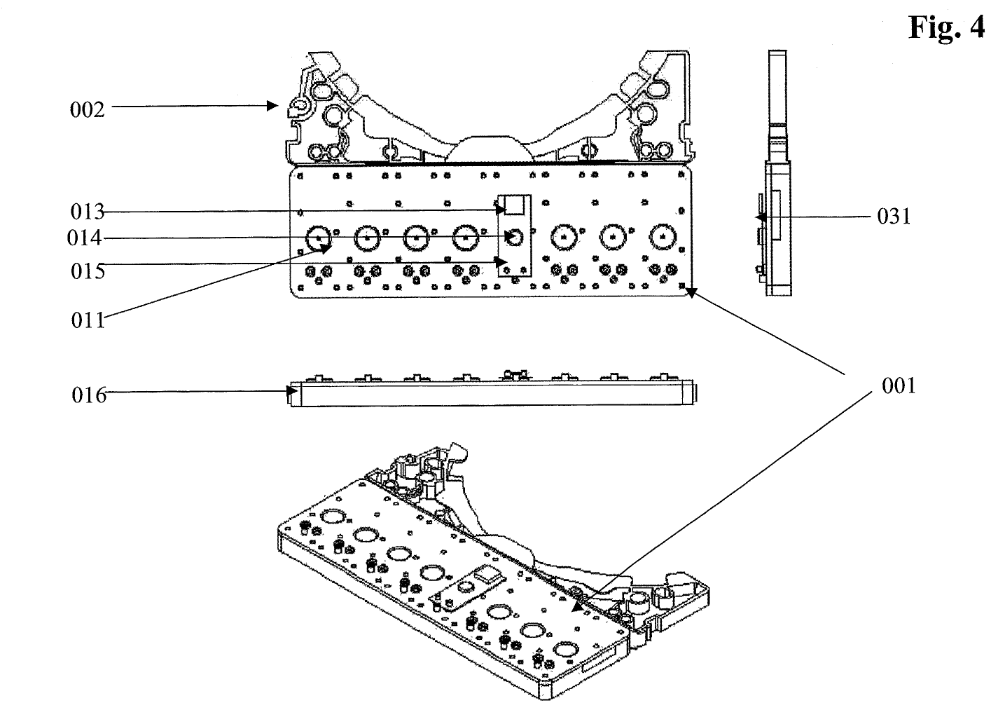

Continuing, the scent card 001 attaches to the slot cover 12 as shown in FIG. 4. The scent card further comprises a magnet 013, an absorbent material 014, a flexible plastic piece 015, and fragrance chambers 016. The side view of the scent card shown in FIG. 4 depicts a slot for accepting a memory storage unit 031. The memory storage unit 031 can comprise SIM, flash memory, or other memory storage devices well known to those skilled in the art. The memory storage unit is used at least for storing scent identification information for identifying scent stored in the scent card. In other preferred embodiments, the memory storage unit can also store scent recovery sequence information for use in coordinating multimedia playback with scent recovery.

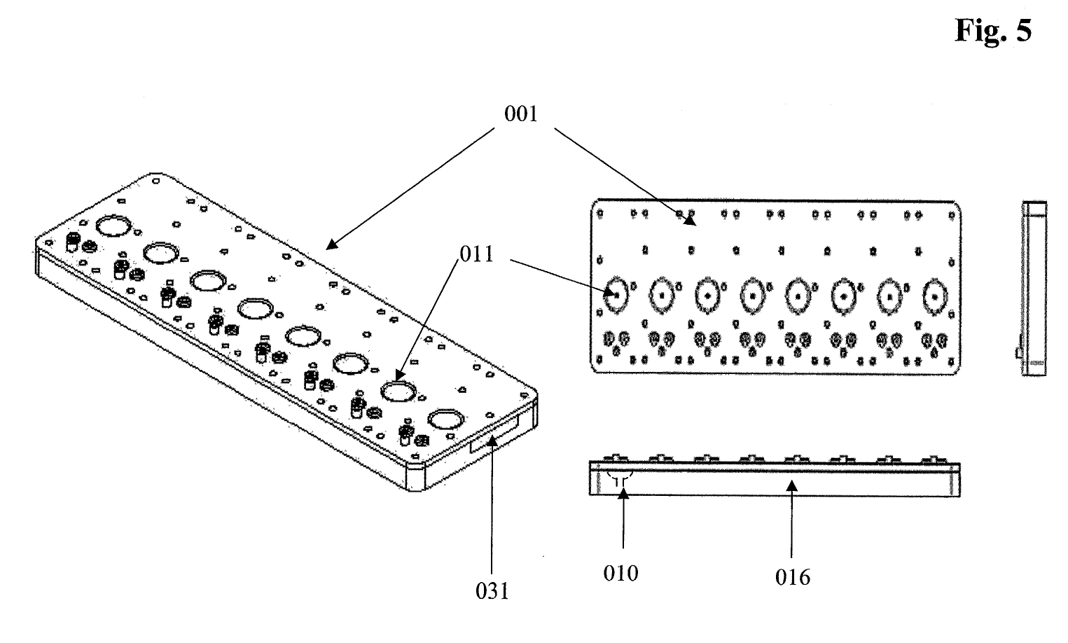

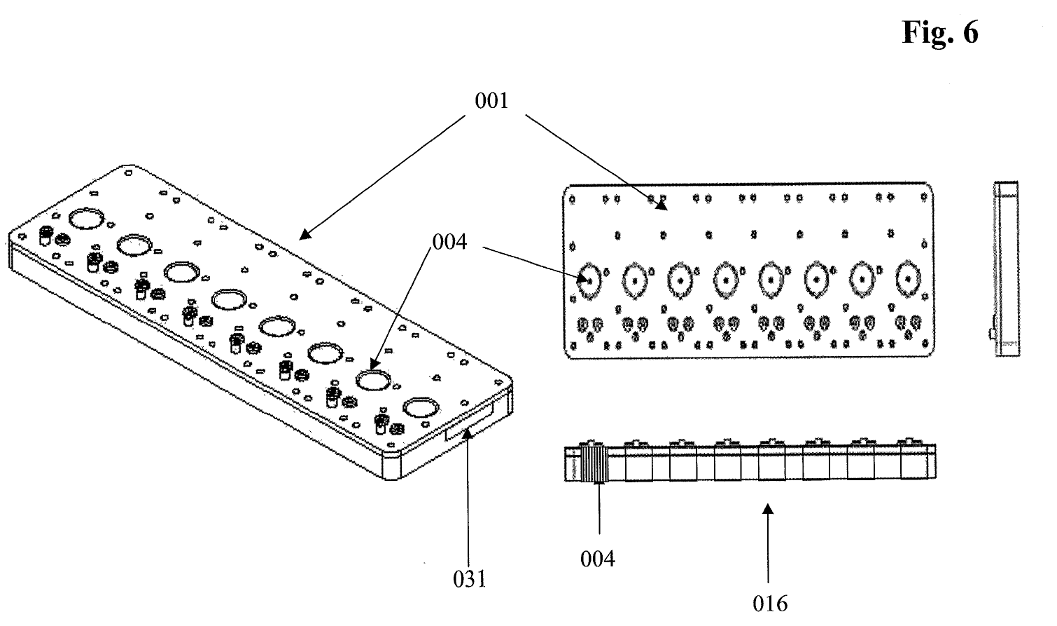

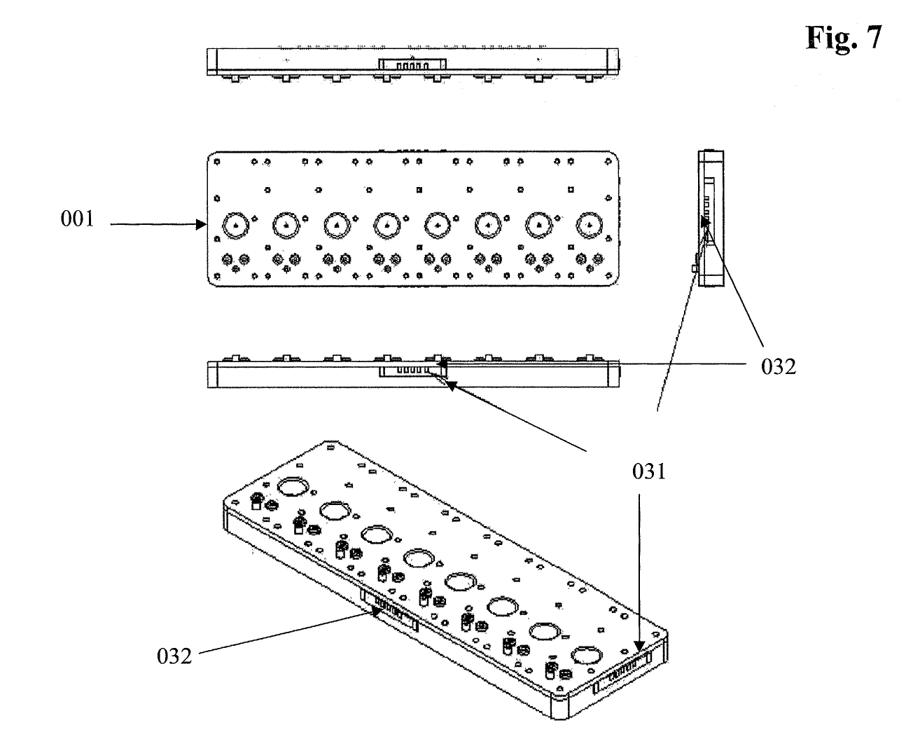

The details of construction of scent card variants made in accordance with a second preferred embodiment of the present invention are generally shown in FIGS. 5-9. The scent card 001 releases scent through scent release openings 011 as depicted in FIG. 5. In the variants depicted in FIGS. 5-9, multiple, different scents are released through each of the scent release openings 011. The scent release openings 011 are connected to scent reservoirs 016 for each scent by capillary tubing 010. The scent card 001 operates under the control of a scent release system (not shown) that can be a stand-alone unit or part of an integrated multimedia playback and scent release system. The scent release system controls the scent card through an electrical interface 032, as shown in FIG. 7. The electrical interface can be variously disposed about the periphery of the scent card as shown in FIG. 7. Scent is released from the scent card using a scent release unit 004 as shown in FIG. 6. The scent release unit comprises at least a capillary tube 010 which conveys scent from the scent reservoir 16 to the scent release opening 011. In variants of the second preferred embodiment, the scent release unit 004 can operate on an evaporation principle, electrostatic principle, or both. The capillary 010 tube is shown immediately beneath the scent release opening 011. Scent stored in the scent reservoir is conveyed by the capillary tube into absorbent material 014.

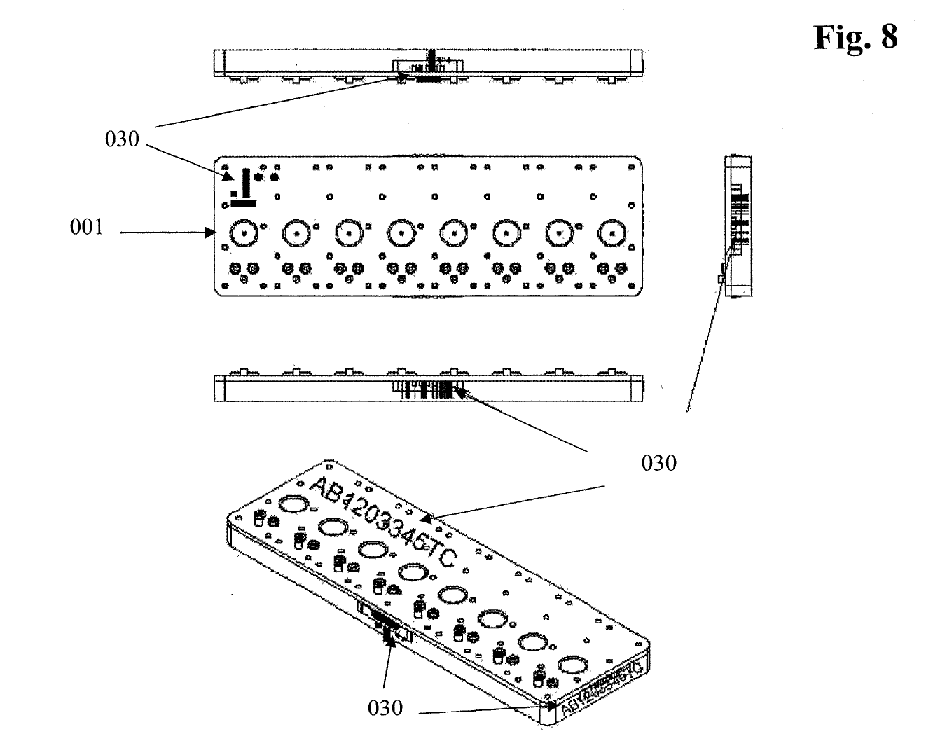

FIG. 8 depicts a scent card 001 having scent identification information 030 printed on its surface. The scent identification information 030 is used by a scent release and multimedia playback system to control release of scent from the scent card 001. The scent identification information 030 can be in human readable form (for example, text) or in machine readable form (for example, bar codes).

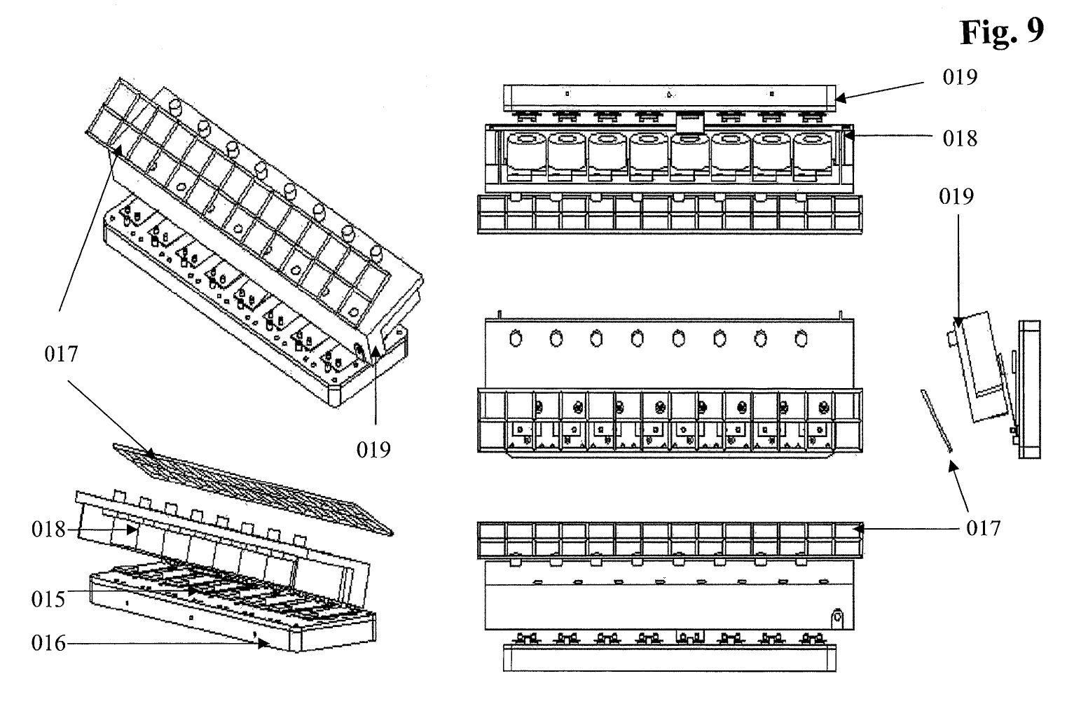

FIG. 9 depicts in partially exploded views the details of construction of a scent card 001 having a scent release module with electrostatic and electromagnetic elements. In one variant, the electrostatic portion of the scent release module comprises at least an electrostatic grid 017 and electrostatic site 019. The electromagnetic portion of the scent release module comprises an electromagnet. Scent or fragrance is stored in a scent reservoir 016.

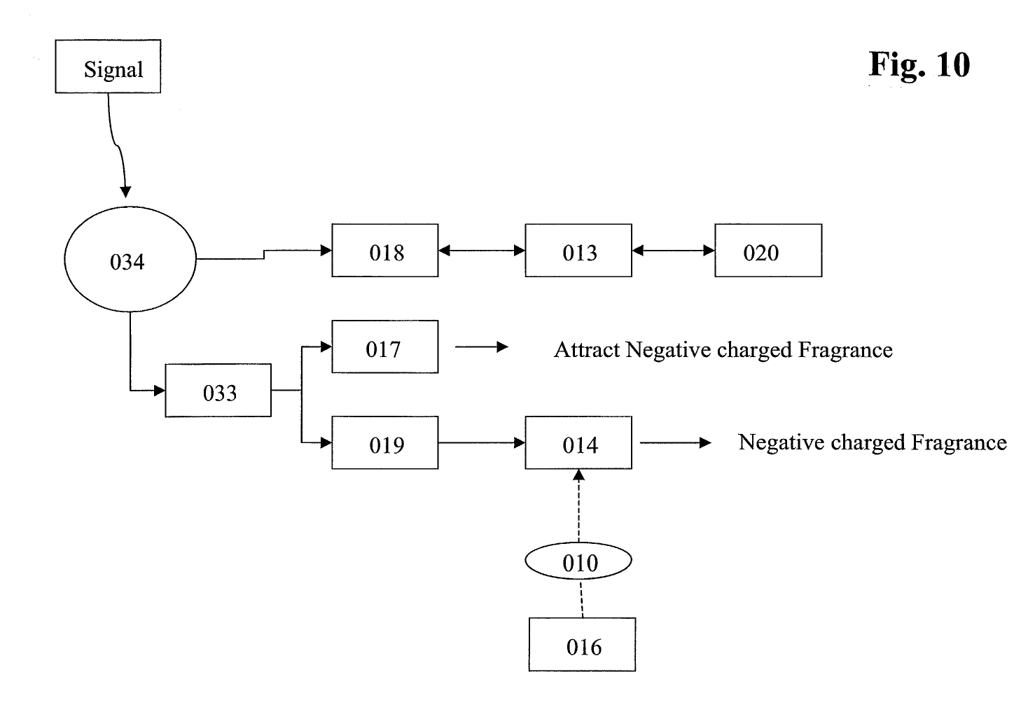

FIG. 10 comprises a block diagram depicting the operation of elements comprising the scent release unit 004 of the scent card 001 operating in accordance with the methods of the third preferred embodiment. In this particular example, only the scent release steps are depicted. The scent release steps shown in FIG. 10 can be combined with multimedia recovery and playback steps. In the method depicted in FIG. 10, a user first inserts the scent card into a scent recovery and release system. A user then instructs the scent recovery and release system to recover and release scent from the scent card. The scent recovery and release system issues an electric signal which is received by the scent card controller 034. The scent card controller 034 then in turn issues an electric signal to the electrostatic charge generator 033. The electric grid 017 then becomes electrically charged. At the same time, the electrostatic site 019 in the absorbent material 014 becomes charged, thereby ionizing the scent molecules that have entered the absorbent material from the scent reservoir 016 through the capillary tubes 010. The ionized scent molecules are attracted to the charged grid 017, thereby improving the rate of entry of scent molecules into the air. Once entrained in the atmosphere, the scent molecules are vented to the user through the scent release opening 011.

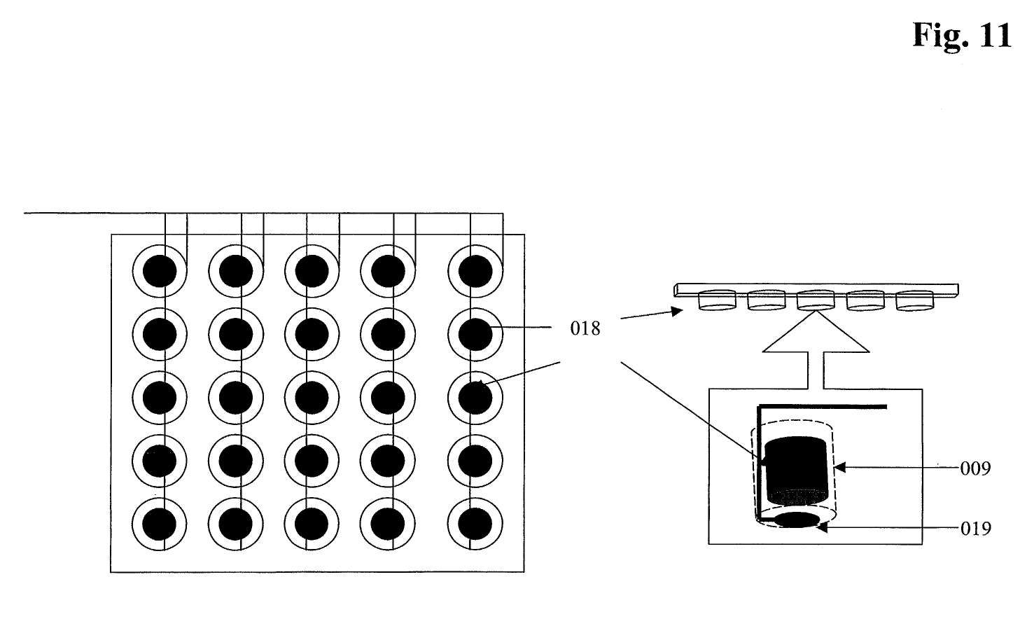

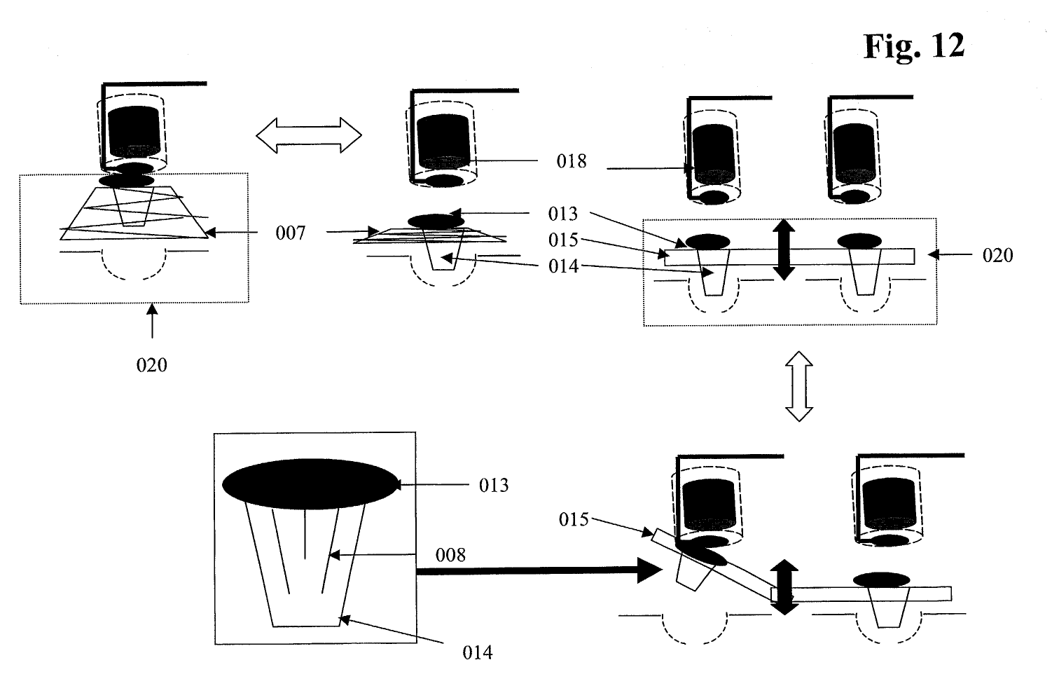

A preferred structure for performing part of this operation is depicted in FIGS. 11-12. The structure depicted in FIG. 11 comprises an array of electrostatic and electromagnetic scent release elements for use in releasing multiple scents. Each scent release opening would have an associated electrostatic site 019 and electromagnet 018. The electrostatic site 019 is where scent ionization occurs. The electromagnet 018 opens and closes a sealing cover that seals the scent release opening between scent release operations. The electromagnet depicted in FIG. 11 is coated with epoxy to protect the electromagnet from the electrostatic scent release apparatus.

After sufficient scent has entered the absorbent material, then the electromagnet is charged as shown in FIG. 12. Absorbent material is contained in each individual scent release assembly 20. The individual scent release assembly is movable as shown in FIG. 12 by the action of the electromagnet 018. The individual scent release assembly 020 comprises an housing; a magnetic cover 013; absorbent material 014; and corona discharge wiring and needle 008. In alternate embodiments, the individual scent release assembly 020 may be either spring mounted or hingedly mounted. During scent release operations, the scent release assembly 020 is initially in a retracted position shown by the compressed spring and closed positions of the hinged cover in FIG. 12. Scent flows into the absorbent material 014 from the scent reservoir through capillary tubes (not shown). The corona discharge needle 008 is then charged, ionizing the scent in the absorbent material. Next the electromagnet is energized, causing the individual scent release assembly to move to an open position, where scent can be released to the atmosphere. After completion of the scent release operation, the electromagnet is de-energized, causing the spiral spring 007 or hinge 015 to return the individual scent release assembly 020 to a closed position immediately adjacent to the capillary tube.

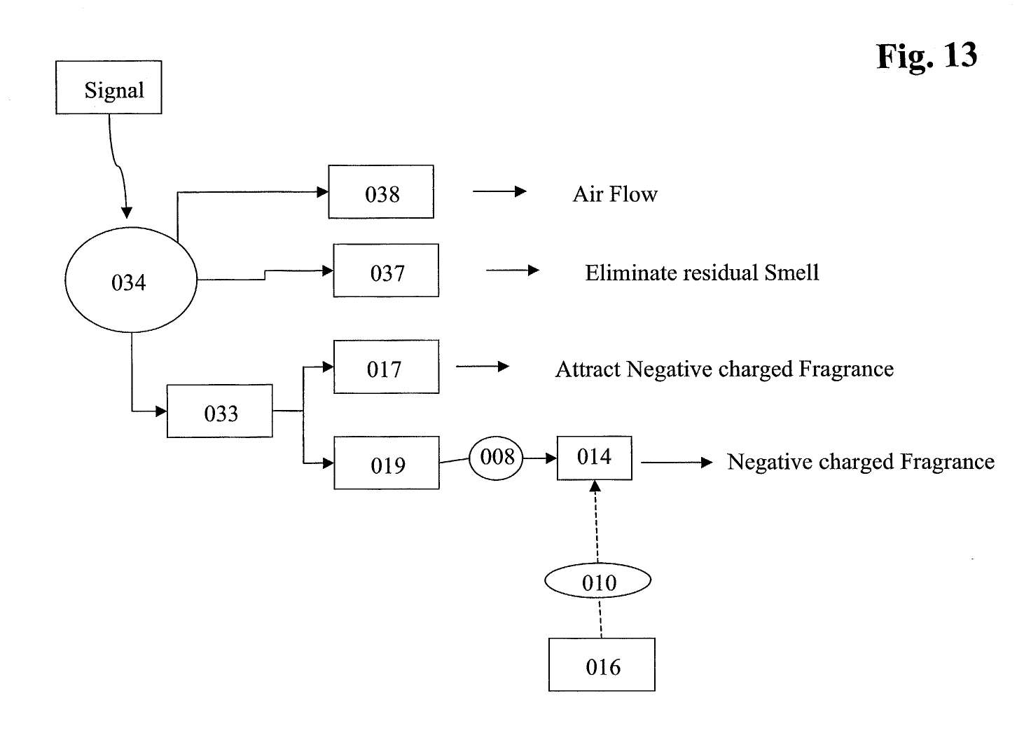

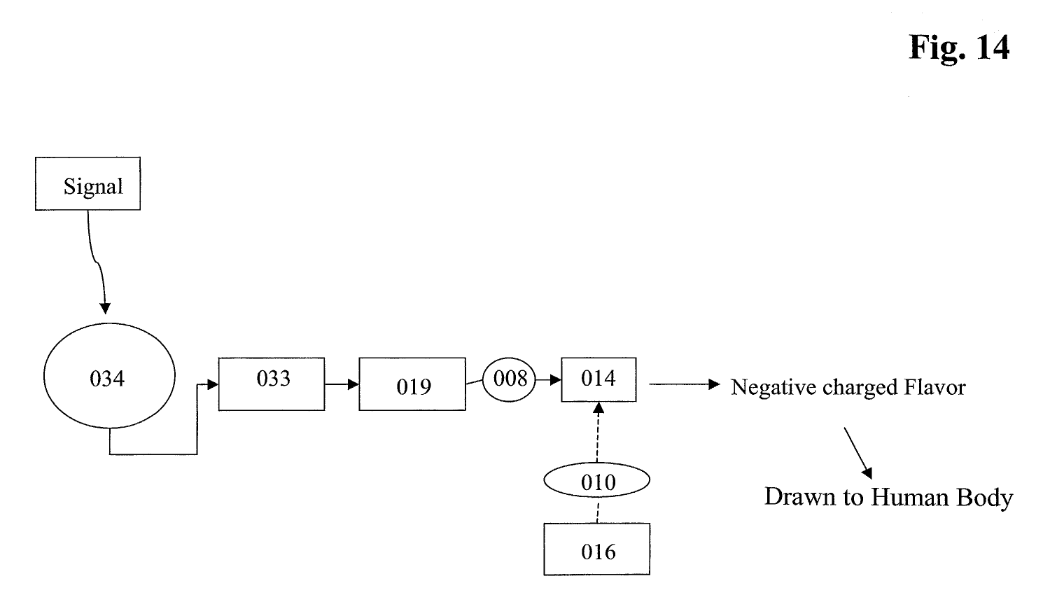

Alternate methods for using the scent cards are shown in FIGS. 13 and 14. In the case of FIG. 13, the scent card player includes an ozone generator which is used to generate ozone to neutralize or degrade previously released scents, or to neutralize or degrade objectionable environmental odors. This is done to heighten the olfactory impact of the next scent released from the scent card. The scent release occurs in the same fashion as in FIG. 10. The user of the scent recovery and multimedia playback system initiates at least a scent recovery sequence by entering a command. The scent recovery and playback system issues a command signal to the scent card microcontroller 034. The scent controller energizes the electrostatic charge generator 033, which ionizes the scent stored in the absorbent material 014. The electrostatic charge is induced through a corona discharge which occurs at needle 008. Once ionized, the scent is attracted to grid 017. The electromagnet is then energized, attracting the magnetic cover 013 and thereby opening the scent releasing opening and allowing scent to flow into ducting. A fan 038 generates a positive pressure so that the released scent may be vented to the user.

In a further variation, the scent release and multimedia playback system and scent card can be used to release flavors, as shown in FIG. 14. The process proceeds in a similar manner as in the preceding descriptions. The user issues a command to the scent recovery and playback system, which in turn issues a command signal to the microcontroller 034. The microcontroller energizes the electrostatic charge generator 033, which ionizes the selected flavor through wiring and the corona discharge needle 008. The flavor contained in the absorbent material is thereby ionized, which allows it to be easily entrained in an air flow, once the scent release opening has been exposed.

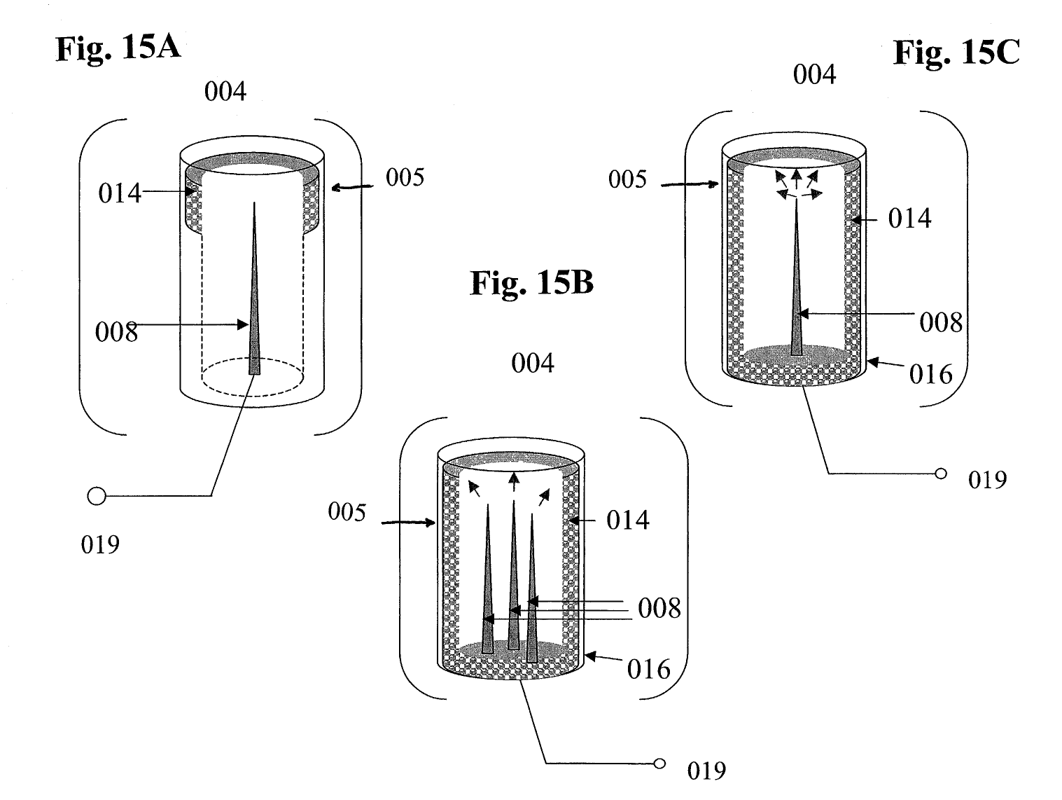

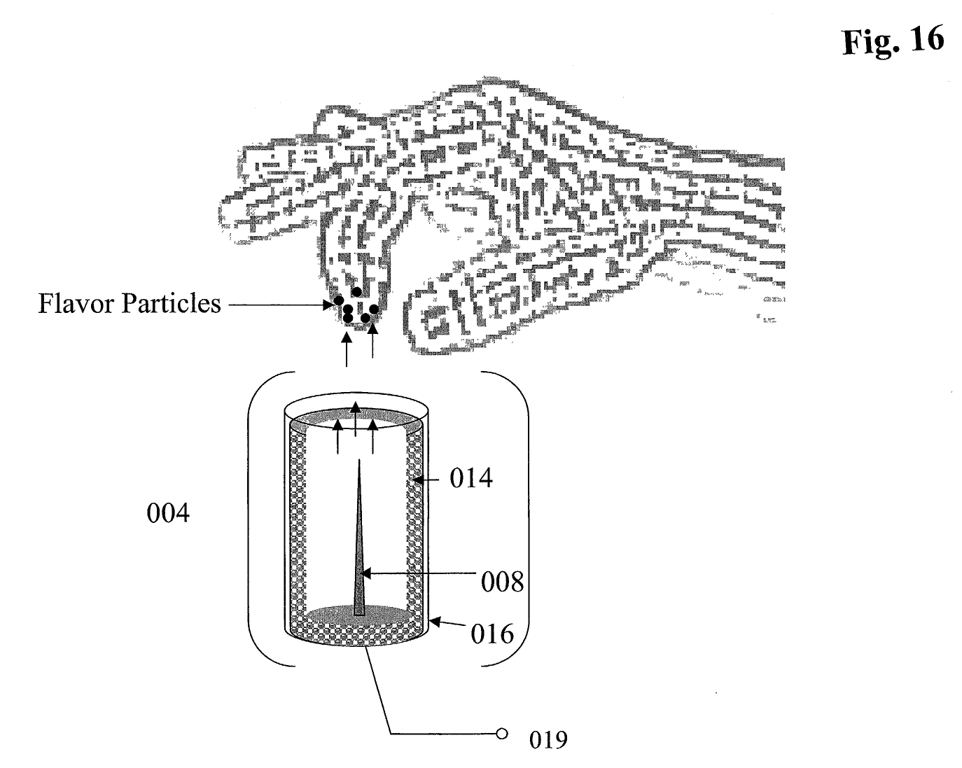

A scent or flavor releasing unit 004 made in accordance with a fifth preferred embodiment of the present invention is generally shown in FIGS. 15A-C. The scent or flavor releasing unit 004 comprises an electrically insulated housing 005 containing liquid absorbent material 014. The absorbent material can be any material that can absorb liquid, such as cotton or sponge-like material. Contained within the absorbent material 014 is the corona discharge needle 008 for ionizing scent or flavor trapped in the absorbent material 004. The corona discharge needle 008 is electrically connected to a high voltage source by wiring. In an alternate embodiment shown in FIG. 15B multiple corona discharge needles 008 may be used to assist in the ionization of scent or flavor molecules. The corona discharge occurs at the tip of the corona discharge needle 008 as shown in FIG. 16. Flavor or scent molecules released in this manner will be attracted to a human hand given the appropriate circumstances, e.g., the presence of static electricity on the hand of user, as shown in FIG. 16.

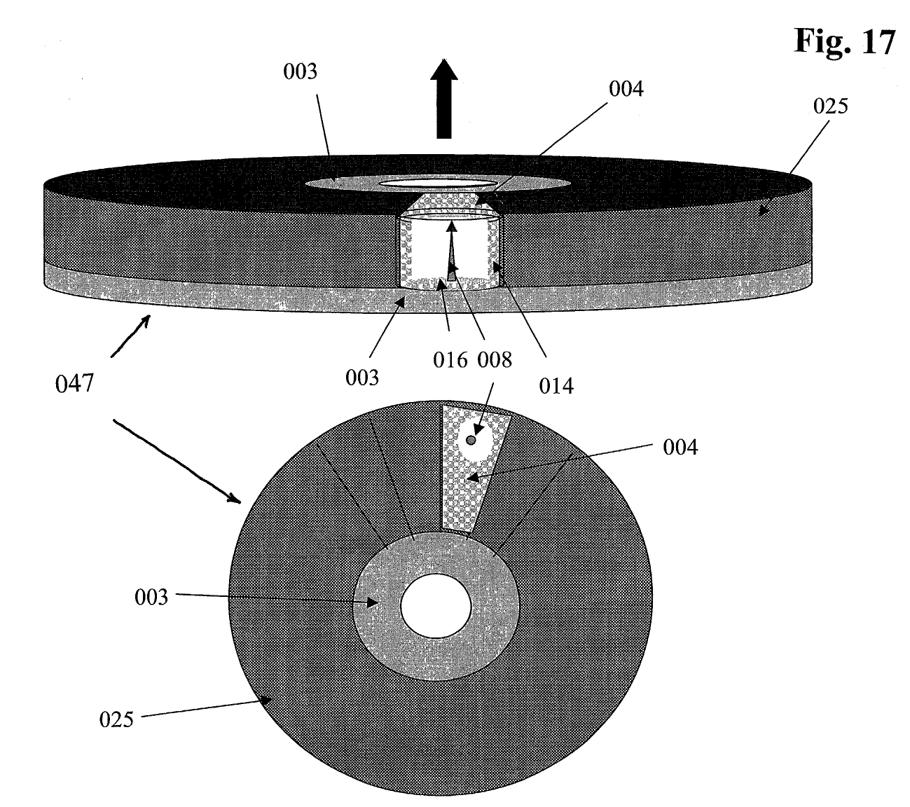

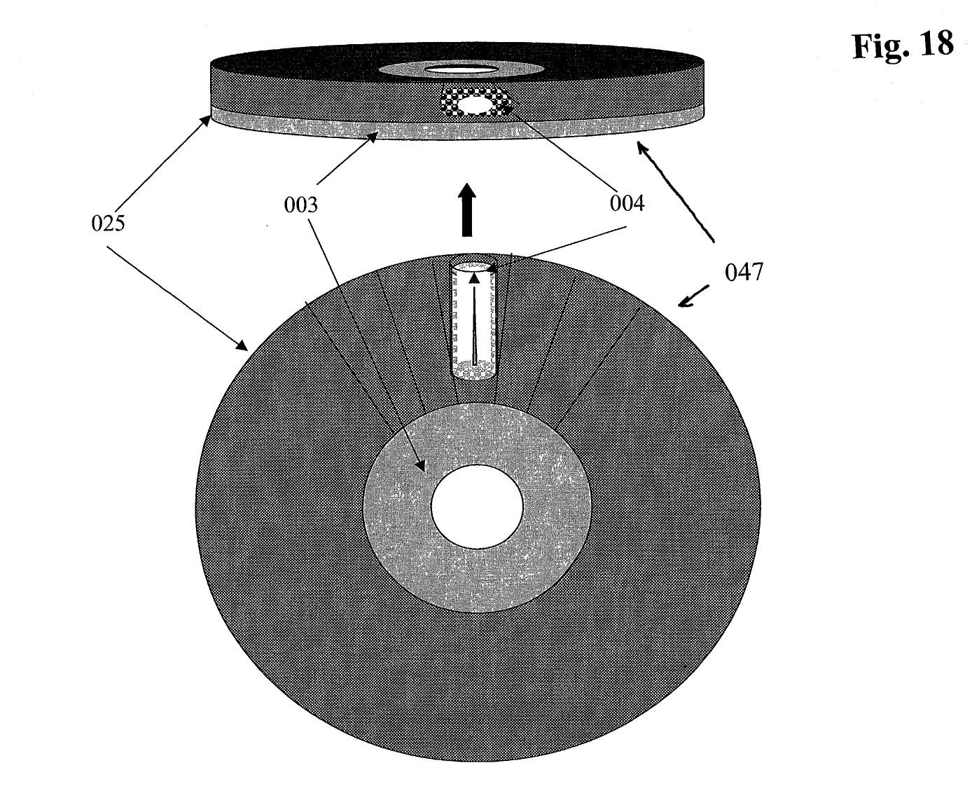

A complete scent- and multimedia-bearing disk 047 having electrostatic scent release and made in accordance with the fifth preferred embodiment of the present invention is shown in FIG. 17. The scent- and multimedia-bearing disk 047 shown in FIG. 17 comprises a plurality of separate flavor releasing units 004, each of which is contained in a three-dimensional sector of the disk. The scent-bearing and multimedia disk 047 has a multimedia region shown in the interior portion of the disk 003. The scent-bearing portion of the disk contains a reservoir connected to the portion of the sector containing the absorbent material 004. Contained within the absorbent material is a corona discharge needle 008. In FIG. 17, the scent and multimedia-bearing disk 047 is designed to vent scent or flavor vertically upward as indicated by the arrow. In an alternate construction shown in FIG. 18, the corona discharge needle extends laterally along a radius of the disk, thereby permitting the scent to be discharged horizontally through an opening in the circumference of the scent- and multimedia-bearing disk 047.

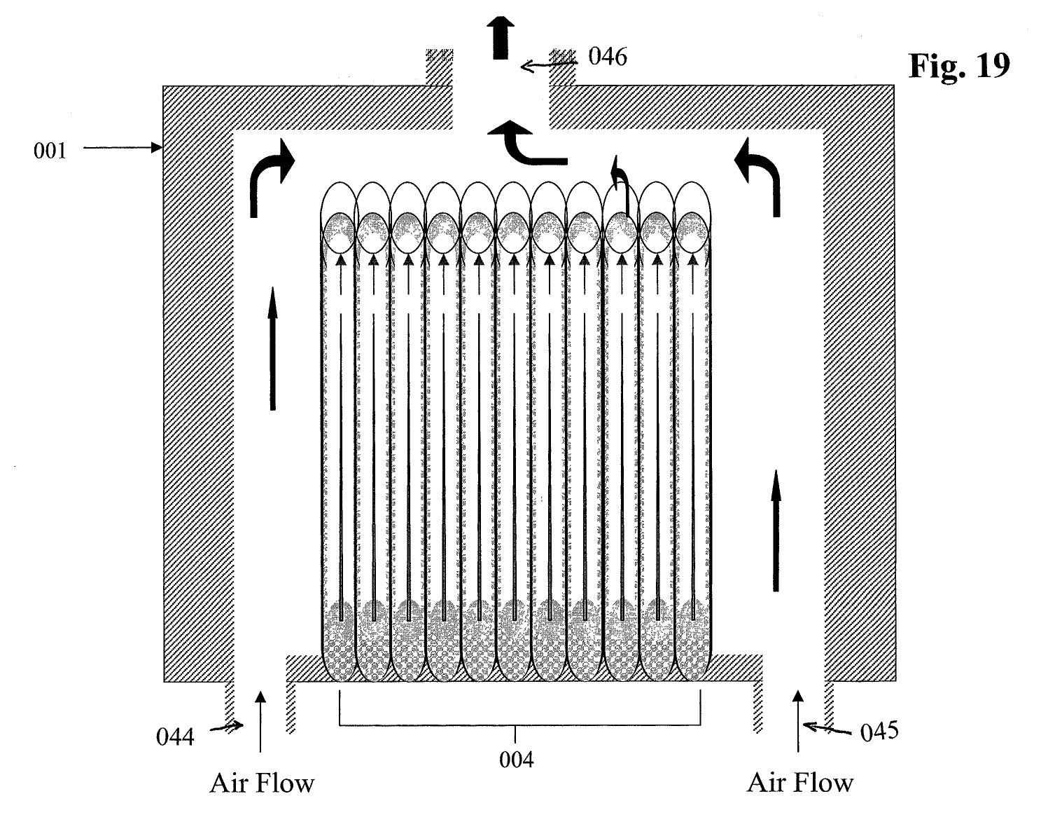

In yet another alternate embodiment suitable for incorporation in a rectangular scent card, a plurality of scent releasing units 004 are shown in FIG. 19. The plurality of scent or flavor releasing units is located in an interior cavity of the scent-bearing and multimedia card 001. The cavity has openings 044 and 045 to accept an air flow generated by a fan. The air flow passes by the open end of the scent or flavor releasing units 004. Ionized scent or flavor released from the absorbent material is entrained in the air flow and vented through opening 046, where it can be experienced by the user.

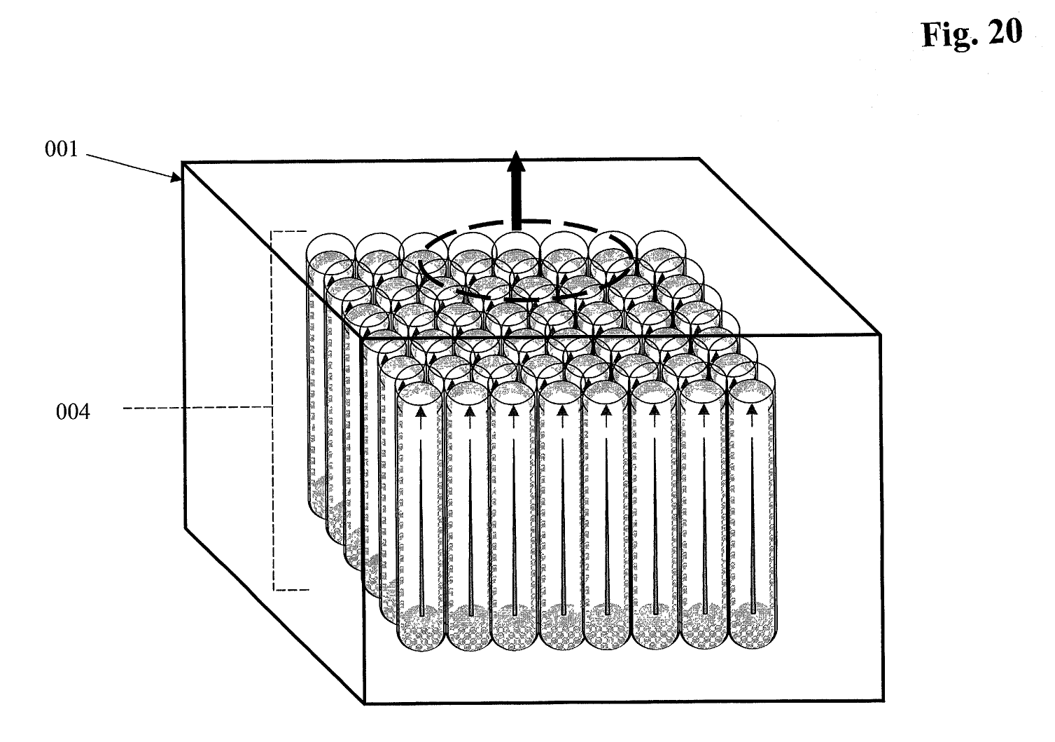

In a still further embodiment of the present invention shown in FIG. 20 a plurality of vertically-oriented scent releasing units 004 are depicted. In the embodiment of FIG. 20, ionized scent released from the scent releasing units is vented vertically.

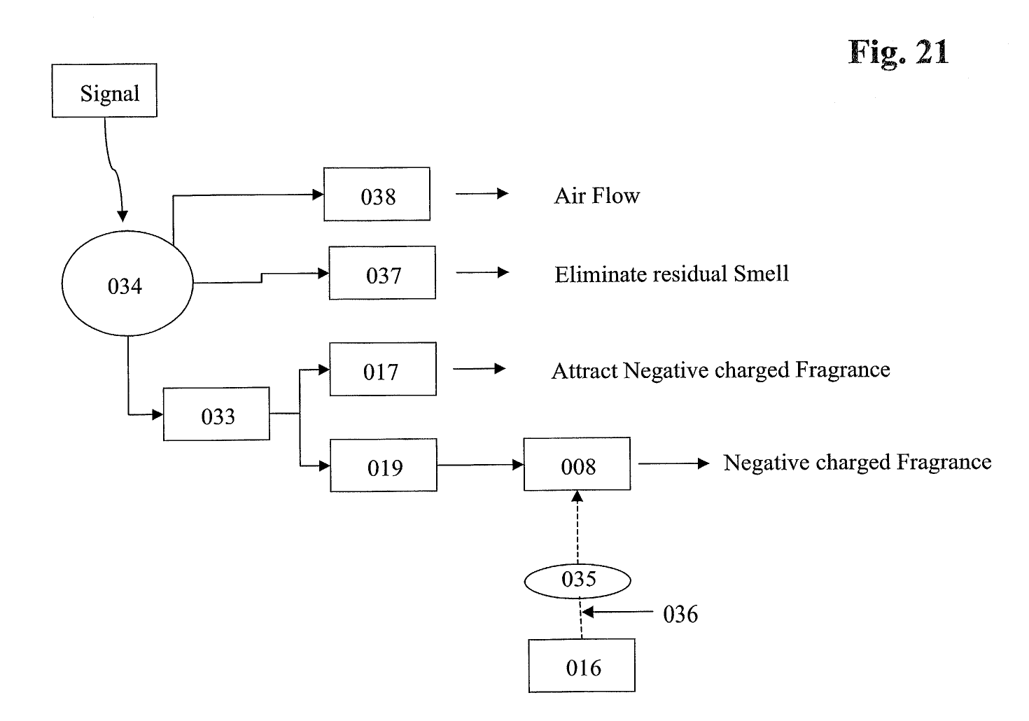

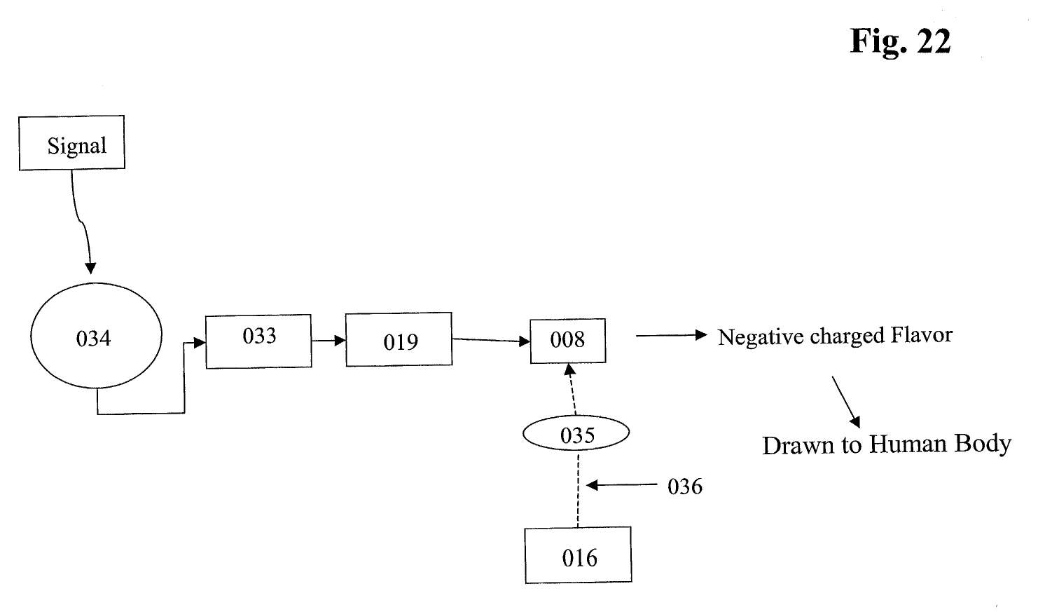

FIGS. 21 and 22 comprise block diagrams depicting the operation of a scent- or flavor-containing disk having piezoelectric scent release apparatus operating in accordance with the methods of an eighth preferred embodiment of the present invention. As in the case of the preceding embodiments, a user places the scent- or flavor-containing card in a scent release system, or a scent release and multimedia playback system. The user then initiates a scent release sequence by operating the input controls of the scent recovery system. The scent release system issues a signal to the microcontroller 034. The microcontroller issues a control signal to electrostatic charge generator 033. The electrostatic charge generator 033 establishes a corona discharge at the electrostatic site 019. In this particular embodiment, the scent or flavor is vented to the electrostatic site absorbent material 014 by a piezoelectric scent discharge system comprising a piezoelectric device 035 and an input tube 036. The piezoelectric device 035 causes scent or flavor in the tube to be released into the region near the corona discharge apparatus 008, thereby ionizing the scent molecules. At the same time the metal grid 017 is charged to attract the ionized scent molecules to a position where they can be vented to a user. As part of this process, when the ionized scent molecules pass through the grid they are lose their charge.

In an alternate embodiment shown in FIG. 22 the scent molecules do not lose their charge. In response to a scent recovery command issued by the user, the microcontroller issues a command to the electrostatic charge generator 033. The scent released from the scent or flavor chamber 016 by the piezoelectric scent release system is ionized at the electrostatic site 019 by the electrostatic charge system 008. In this example, the ionized scent or molecules are left in their charged state. In this variation, the charged scent molecules will be attracted to the user of the system due to the static charge of the user, thereby improving the scent or flavor experience.

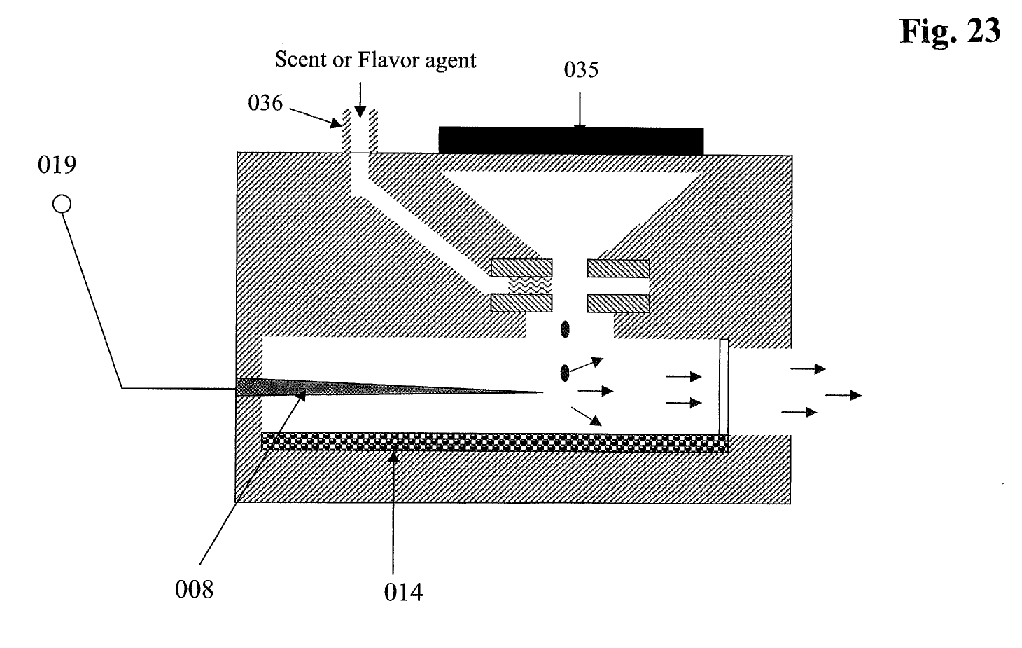

FIG. 23 depicts a structure capable of performing the preceding steps which is made in accordance with a seventh preferred embodiment of the present invention. Scent or flavor agents from a storage reservoir are introduced into the structure through an input tube 036. The piezoelectric scent release system 035 which is periodically charged causes the scent in the input tube 036 to drop into a region immediately adjacent to the electrostatic discharge needle 008, where the scent is ionized. The ionized scent is then drawn to the positively charged grid 017 (not shown) or to the user.

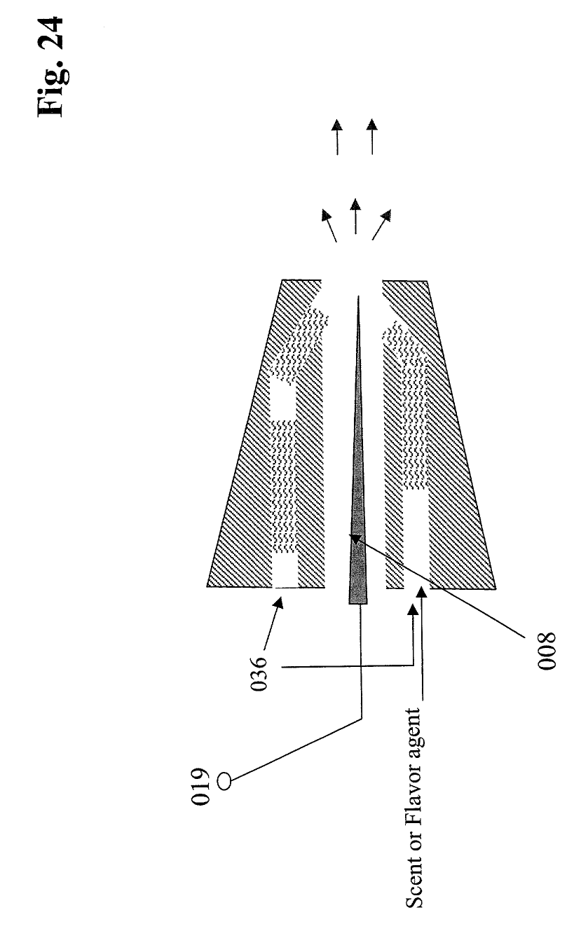

An alternate structure is depicted in FIG. 24. Here a conically-shaped structure containing input tubes 036 is used to release the scent or flavor molecules. The scent or flavor molecules flow into the region adjacent to the electrostatic discharge needle 008 where they are ionized. This structure can also incorporate a piezoelectric scent release device.

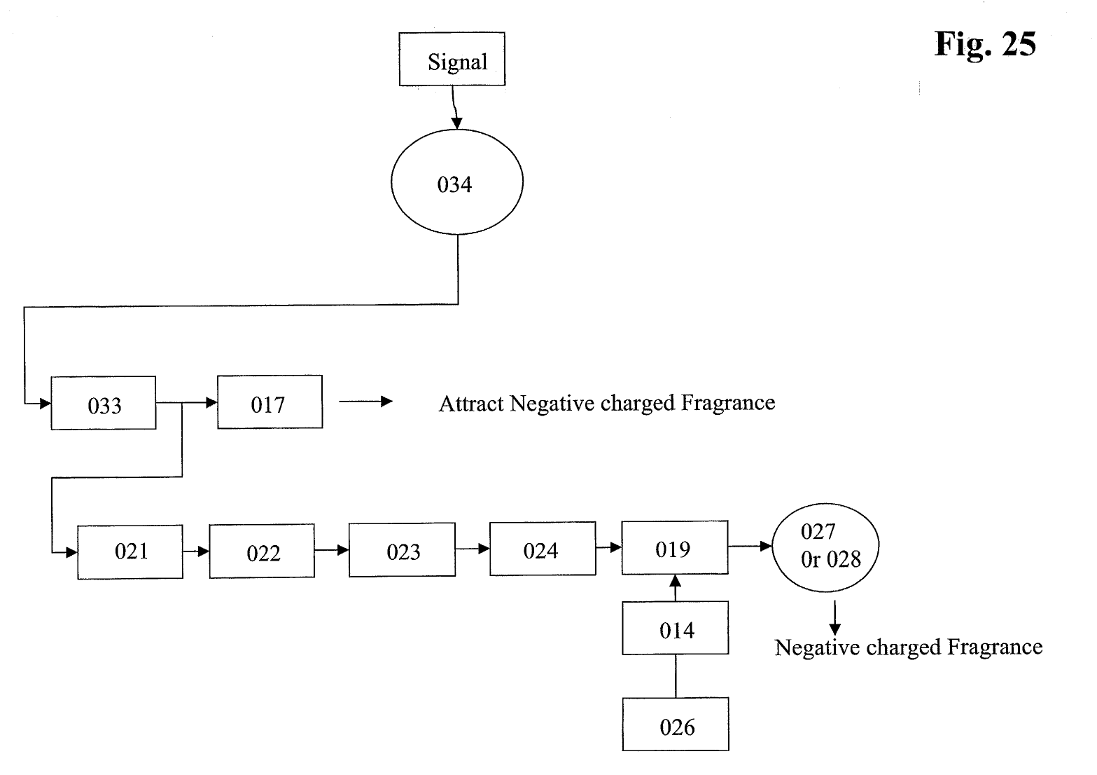

FIG. 25 comprises a block diagram depicting the operation of a scent- and multimedia-bearing disk having an electrostatic top supply module operating in accordance with a ninth preferred embodiment of the present invention. As in the case of the preceding embodiments, the user issues a signal to the scent recovery and playback system to release scent from the scent-bearing and multimedia card. The scent recovery and multimedia playback system then issues a signal to the microcontroller 034. The microcontroller 034 then issues a command signal, thereby energizing electrostatic charge generator 033. The electrostatic charge generator then ionizes the scent, fragrance, aroma or flavor to be released. The metal grid 017 is energized at the same time to attract the ionized molecules to aid in the scent release process.

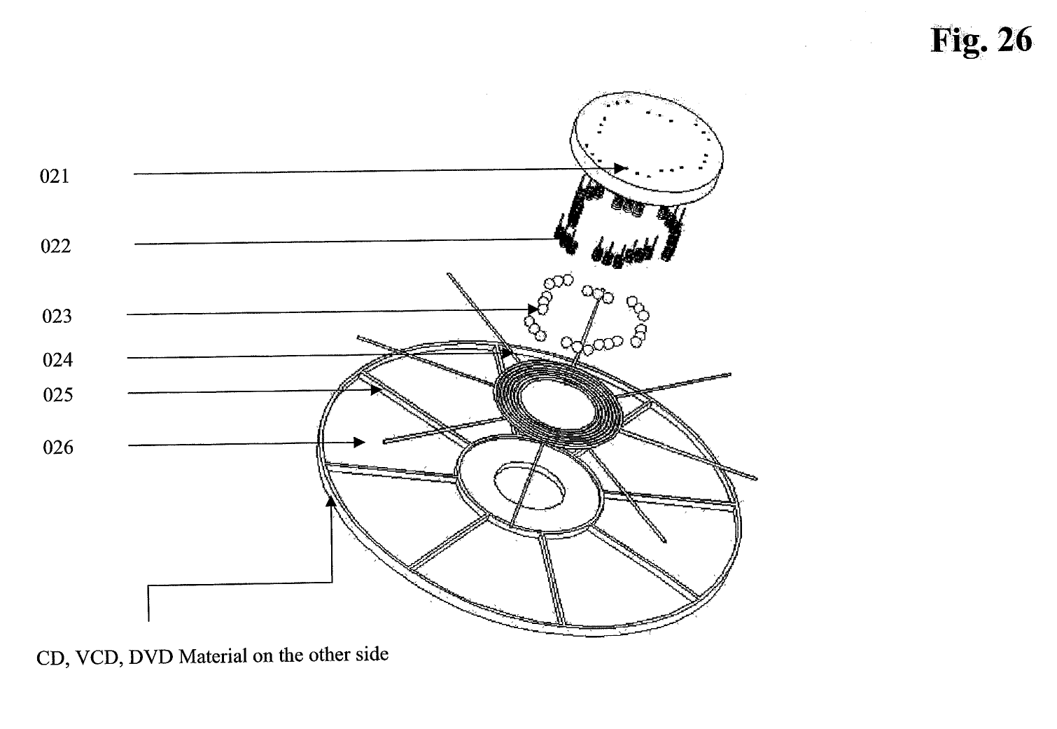

The operation of this further embodiment permits scent to be released without interrupting the operation of multimedia information recovery from the multimedia portion of the multimedia- and scent-bearing disk shown in FIG. 26. The scent ionization is accomplished through the electrostatic top supply module 021. Electric potential is applied to the electrostatic wiring 024 through the cooperation of the springs 022 and metal balls 023. The metal balls 023 maintain electrical contact between the electrostatic top supply module 021 and the electrostatic wiring 024 as the disk rotates. The springs 024 maintain the balls in place to maintain a continuous and uninterrupted electrical contact between the electrostatic top supply module and the electrostatic wiring 024. The electric potential is then applied at the electrostatic site 019. Scent, fragrance, aroma or flavor in the scent reservoir 026 is released into the absorbent material 014 surrounding the electrostatic site 019. The scent-release valve 028 is then opened, allowing the scent to escape from the scent release unit. An air flow is created in ductwork adjacent to the scent release valve of the scent disk, and this airflow entrains the released scent, fragrance, aroma or flavor. The ductwork of the scent release system then vents the entrained scent, fragrance, aroma or flavor to the vicinity of the user, thereby causing an olfactory or taste sensation in the user.

The construction of the scent disk is depicted in FIG. 26 in a partially exploded view. The scent storage and release portion of the disk is positioned on the side opposite from the side containing the optically encoded information. The scent is stored in fragrance cells 026, which are shown with the top surface removed so that the reservoir area is visible. The electrostatic wiring 024 is disposed about the center of the disk, and each cell 026 has wiring extending along a radius outward from the center to assist in scent release. The metal balls 023 are placed above the wires 024 and maintain electrical contact between the electrostatic top supply module 021 and the electrostatic wiring 024. Springs 022 maintain the metallic balls 023 in contact with the electrostatic wiring 024 as the scent disk 025 rotates. The electrostatic top supply module 021 does not rotate.

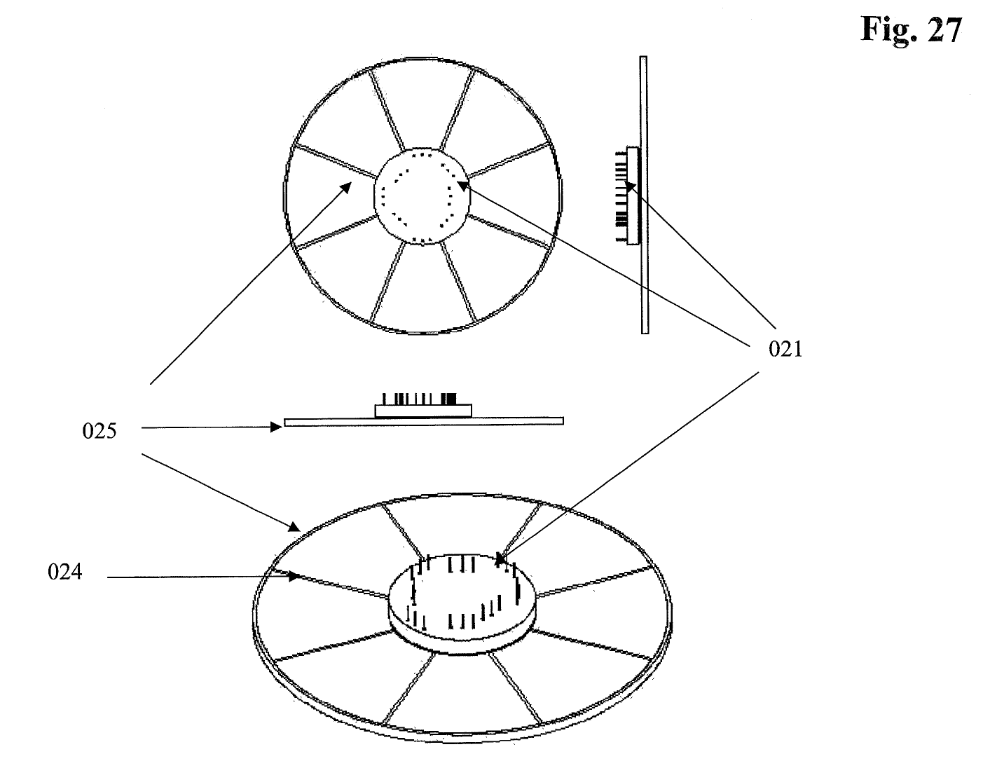

A scent bearing and multimedia disk having an electrostatic top supply module is shown assembled from various perspectives in FIG. 27. The electrostatic top supply module sits atop the scent disk main structure 025. The electrostatic scent release units are supplied with electric potential through wires 024. The electrostatic top supply module 021 remains stationary as the scent disk rotates. As a result, scent release operations do not interfere with multimedia recovery and recording operations that involve the opposite side of the scent- and multimedia bearing disk. In fact, these operations can occur simultaneously. Further, the electrostatic top supply module 021 design permits multiple scents to be released at the same time.

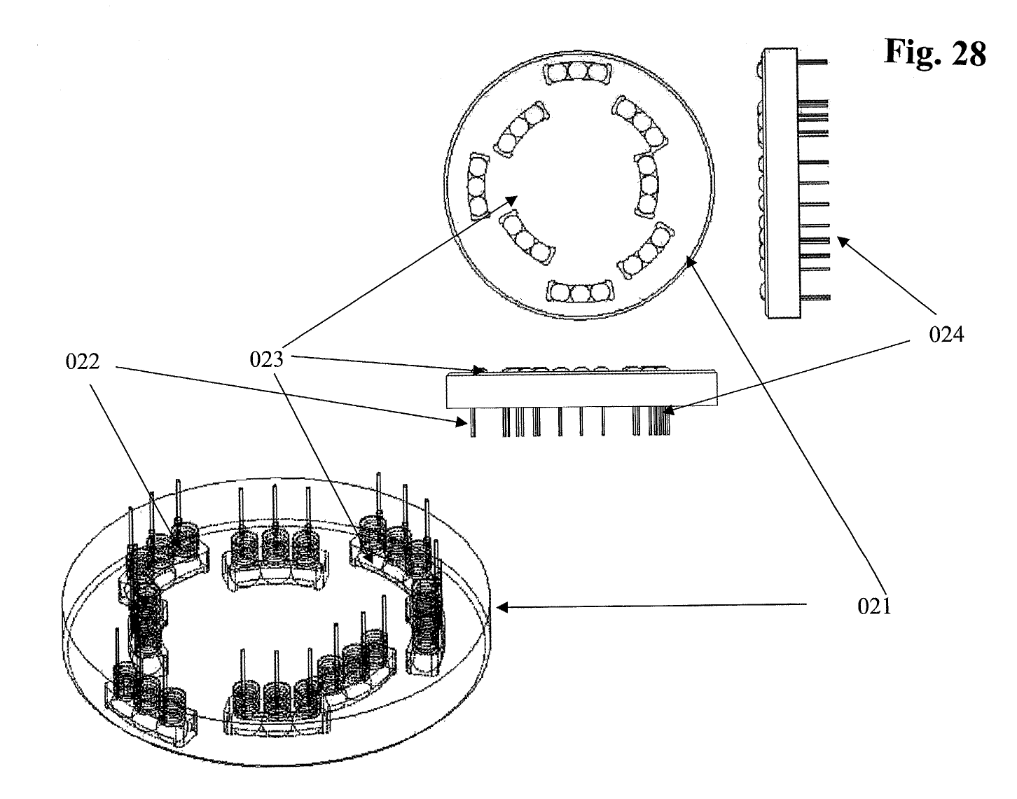

The details of the electrostatic top supply module design are shown in cut-away view in FIG. 28. As is apparent, the spring 022 and metallic ball 023 assemblies are staggered around the circumference of the electrostatic top supply module 021. This permits the independent control and operation of scent release from eight different scent storage sectors each of which contain fragrance cells 026.

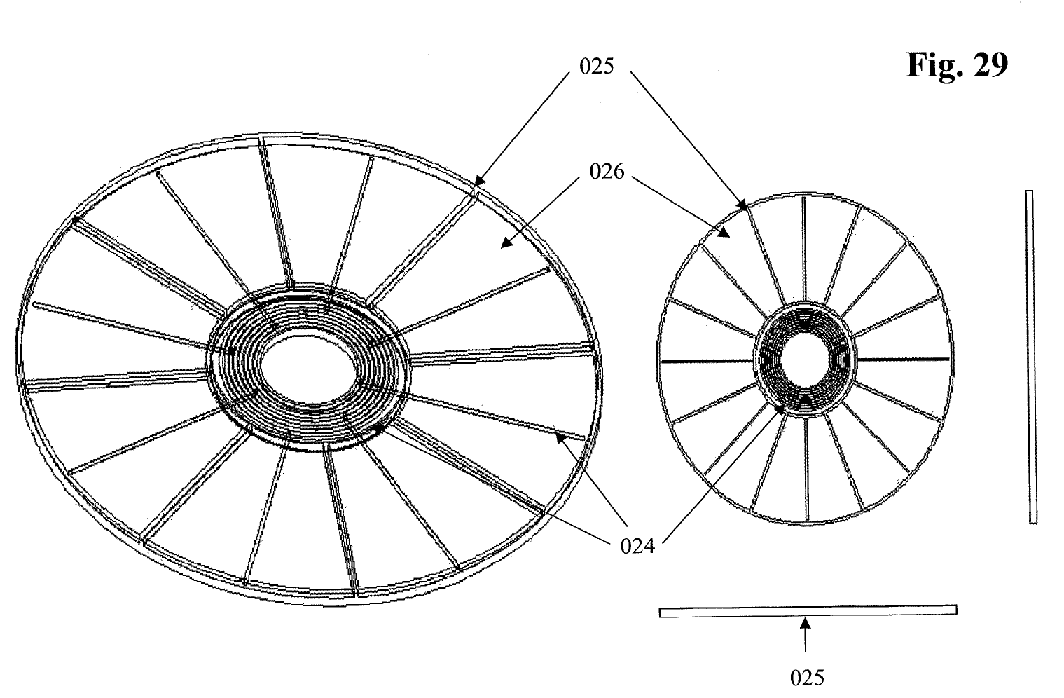

The details of the electrostatic wiring 024 are shown to better advantage in FIG. 29. There are eight wiring tracks to control independent scent release operation in each of the fragrance cells 026. The wiring extends along radii outward from the center of the scent- and multimedia-bearing disk supplies electric potential to the fragrance cells 026 where the electrostatic discharge occurs.

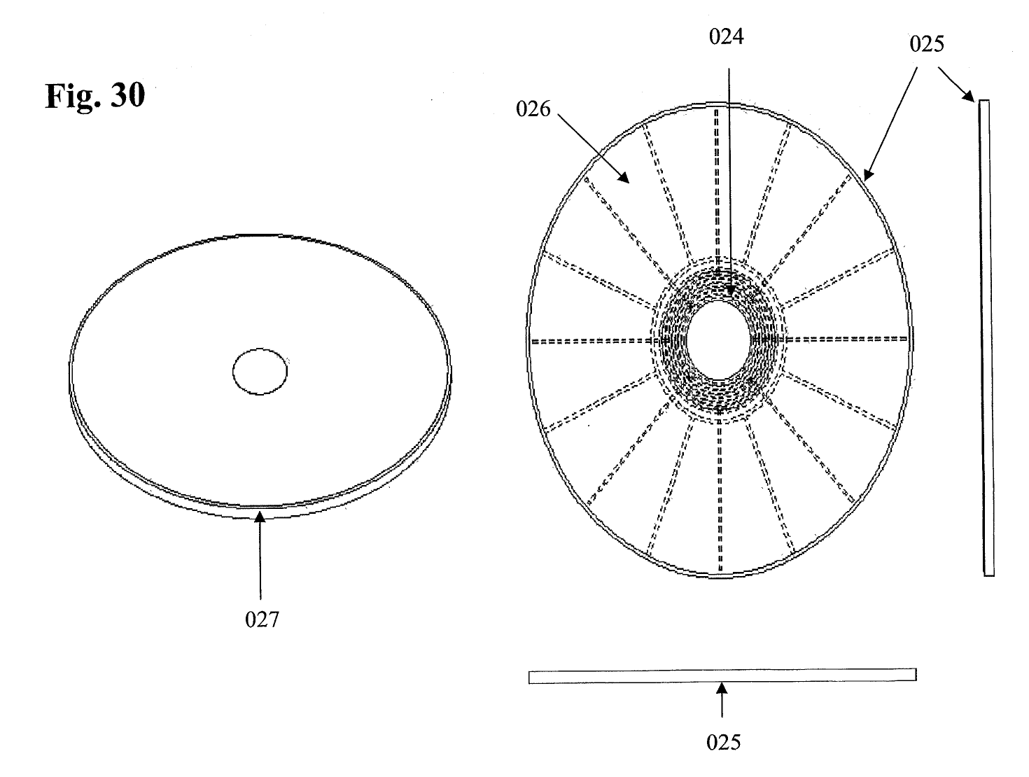

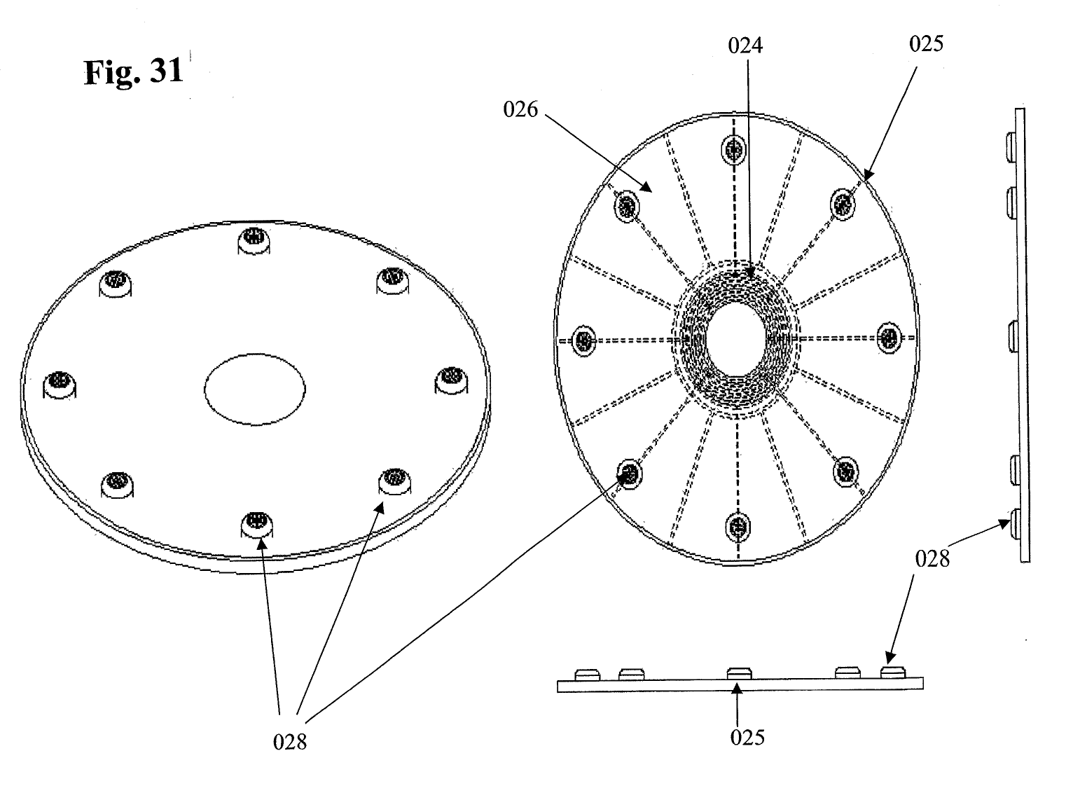

The scent-bearing and multimedia disk is intended to operate with an integrated scent recovery/release and multimedia playback system (not shown). Such a system would have a fan and venting system for entraining fragrance released from the scent- and multimedia-bearing disk and venting the fragrance to the user. The scent- and multimedia-bearing disk must retain the scent between scent release operations. This can be accomplished in at least two ways, as shown in FIGS. 30 and 31. In FIG. 30, scent is retained in the scent- and multimedia-bearing disk by a gas-permeable membrane 027 until ionized scent is created during operation of the electrostatic discharge system. When ionized scent is created in the regions between the gas-permeable membrane 027 and the fragrance cells 026 (the gas permeable membrane 027 rests atop the fragrance cells 026) the ionized scent passes through the gas permeable membrane. The released scent is then entrained into the air flow created by the fan and venting system of the scent recovery/release and multimedia playback system.

In a variant depicted in FIG. 31, scent released from fragrance cells 026 is released from the scent- and multimedia-bearing disk by single release valves 028. The single release values are sensitive to pressure differentials between the region within the scent- and multimedia-bearing disk and the region immediately above the scent- and multimedia-bearing disk. When ionized fragrance is created within the scent- and multimedia bearing disk, it creates a pressure differential between the region within the scent- and multimedia-bearing disk and immediately outside the disk. This pressure differential causes the single release valves to open, thereby releasing the fragrance to the scent recovery/release system and multimedia playback system where it can be vented to the user. Eventually, when pressure equilibrium is reestablished, the single release valves 028 close. In addition, the single release valves permit air flow in only one direction, and prevent air from outside the scent- and multimedia-bearing disk from flowing into the disk and possibly degrading stored fragrances.

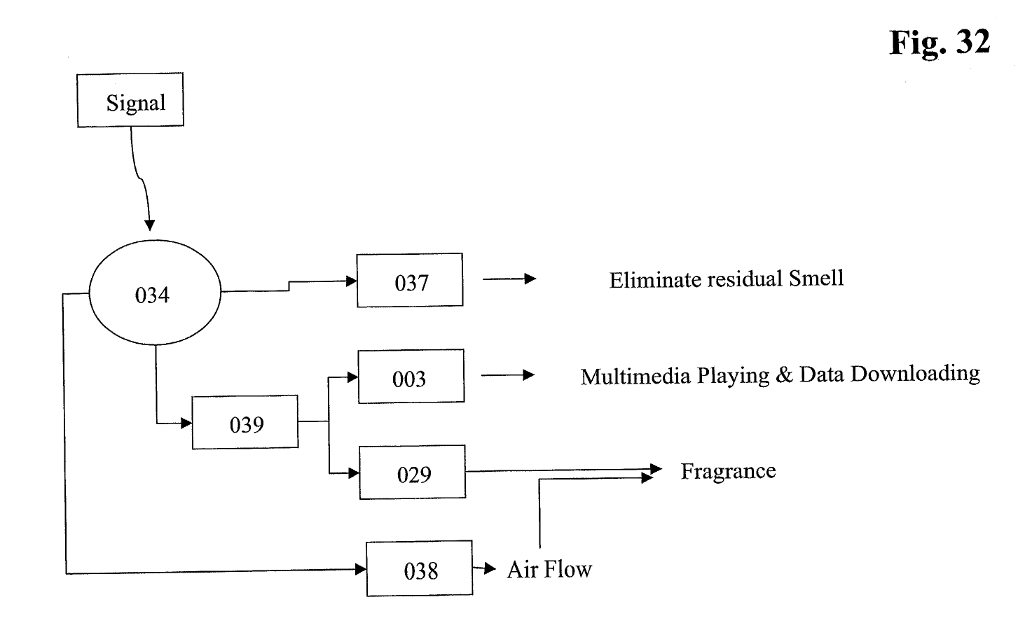

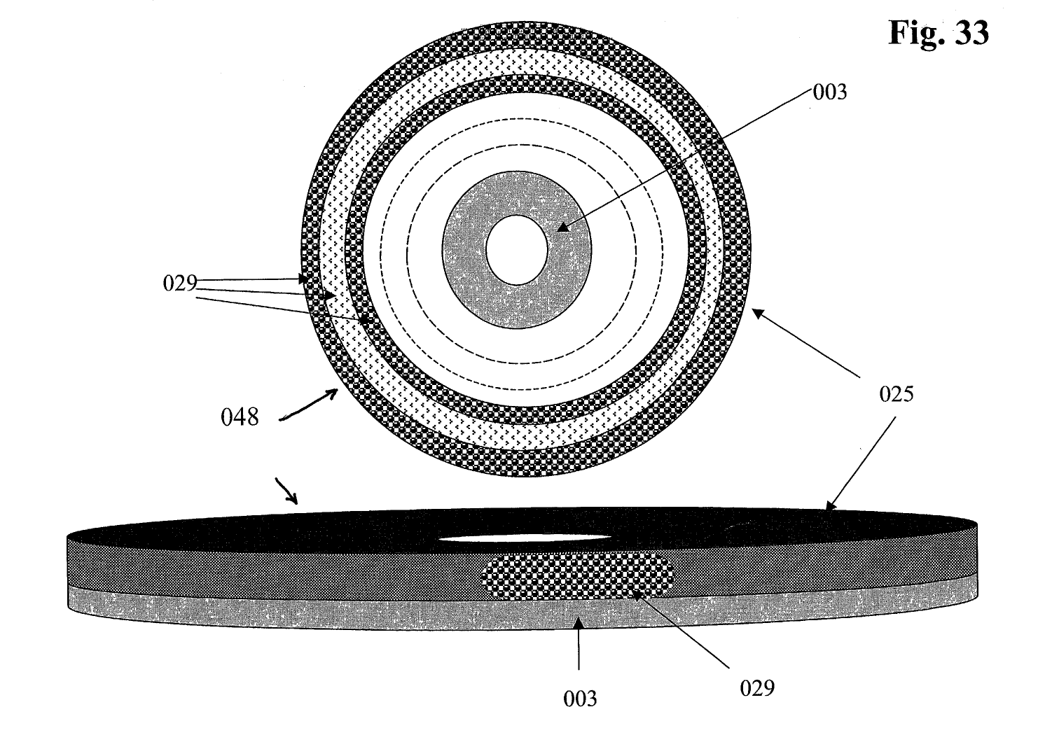

FIGS. 32-33 depict methods and apparatus comprising a tenth preferred embodiment of the present invention. The scent- and multimedia-bearing disk of this embodiment is intended to operate with a scent recovery/release and multimedia system having a laser-based scent release system. The operation of the scent recovery/release and multimedia playback system during a scent release operation is shown in FIG. 32. The scent release/recovery and multimedia playback system receives a scent release command input from a user (not shown). The scent release/recovery and multimedia playback system then issues a signal to the microcontroller 034, instructing the microcontroller to initiate a scent release operation. The microcontroller 034 energizes the scent release portion of the laser system 039. The laser light thereby created bombards the fragrance-bearing region 029 of the scent- and multimedia-bearing disk. This causes microencapsulated fragrance, scent, aroma or flavor to be released from the multimedia- and scent-bearing disk. The scent is stored in organic materials well-known to those skilled in the art that are sensitive to laser light in the 720 nm wavelength range. During scent release operations, the scent recovery/release and multimedia playback system uses the fan and venting system to create an air flow immediately above the fragrance-bearing portions 029 of the scent- and multimedia-bearing disk. The released fragrance, scent, flavor or aroma is entrained in the air flow and then vented to the user of the scent recovery/release and multimedia playback system. The multimedia playback portion of the laser system 039 can be used to recover multimedia information from the multimedia portion 003 of the scent- and multimedia-bearing portion of the scent- and multimedia-bearing disk, or to record multimedia information in this region. The recorded information can also include user-created simultaneous scent release and multimedia playback sequences.

The scent- and multimedia-bearing disk 048 of the tenth embodiment is depicted in FIG. 33. The fragrance, scent, flavor or aroma is stored in microencapsulated form in the material comprising concentric rings 029. When this portion of the scent- and multimedia-bearing disk is illuminated by laser light, the microencapsulated scent is released. The optical portion of the disk is shown in the inner ring 003. Although concentric rings are shown other configurations are possible. A particularly desirable feature of this configuration is that individual scent or fragrance modules may be replaced. Since the microencapsulated scent is in solid state, individual rings or sectors can be made. When one is exhausted, a user need merely replace the particular ring or sector, and need not replace the entire scent- and multimedia-bearing disk.

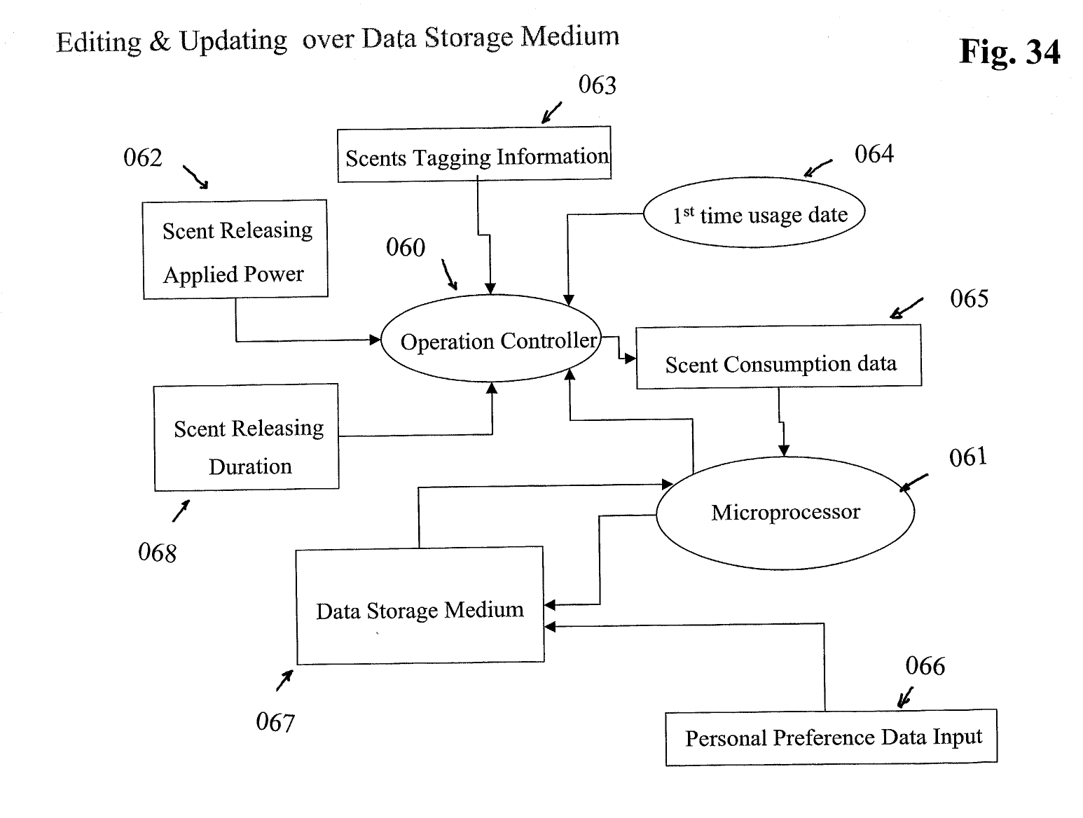

FIG. 34 depicts an eleventh preferred embodiment of the present invention. The eleventh embodiment of the present invention is intended to facilitate the continuous use of the scent- and multimedia-bearing disk and related scent release and multimedia playback system. In order so that the user will be aware of the amount of scent, fragrance, aroma or flavor remaining in the scent- and multimedia-bearing disk, and whether the disk needs to be replaced or replenished, the scent release and multimedia playback system incorporates a scent release monitoring feature. As scent release operations occur, the operations controller 060 of the scent release and multimedia playback system monitors the particular scents that have been released through scent tagging feature at step 063, and records this information in non-volatile memory 067. In the cases of both electrostatic-based and laser-based scent release systems, the scent recovery/release and multimedia playback system monitors the scent release power applied at step 062, and the duration of scent release at step 068. From all of this information the operation controller 060 and microprocessor 061 can calculate scent consumption data 065, including when particular scents will be exhausted. This information can be used by the system to automatically apprise the user when a certain percentage of depletion has been reached, or it can be made available to the user on a purely demand basis. In either situation, the user will remain aware of the depletion status of individual scent cells in a scent- and multimedia-bearing disk, and will know when they will need to be replaced.

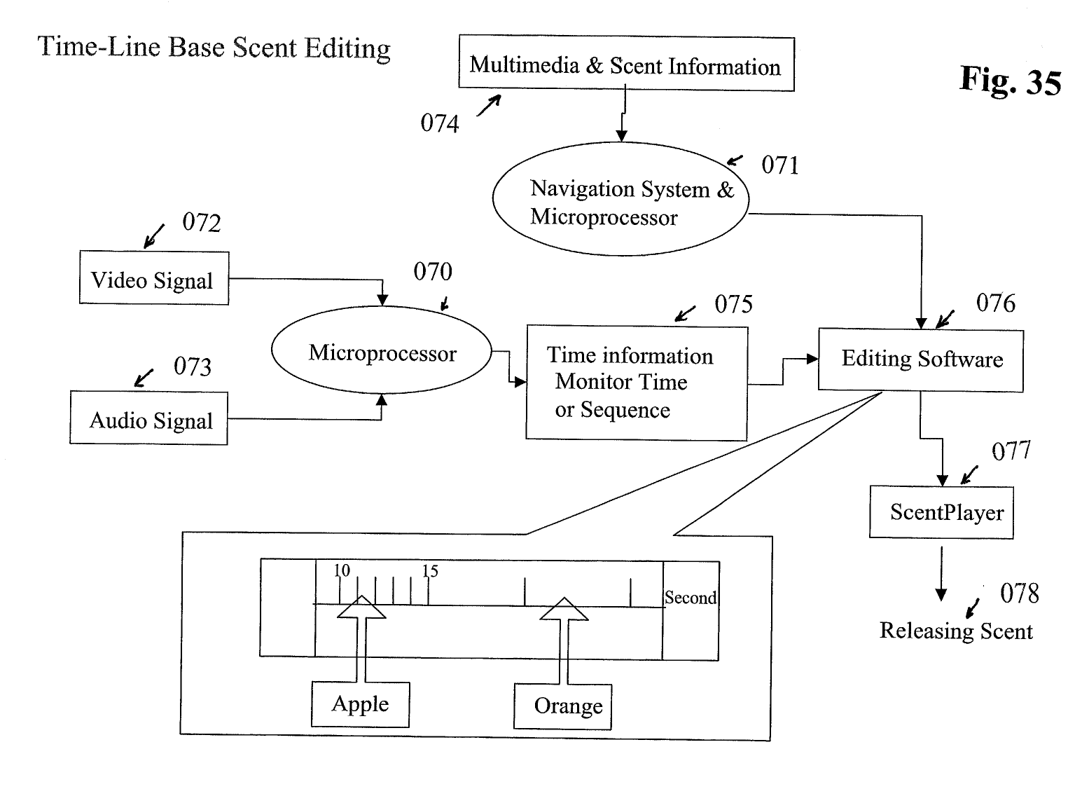

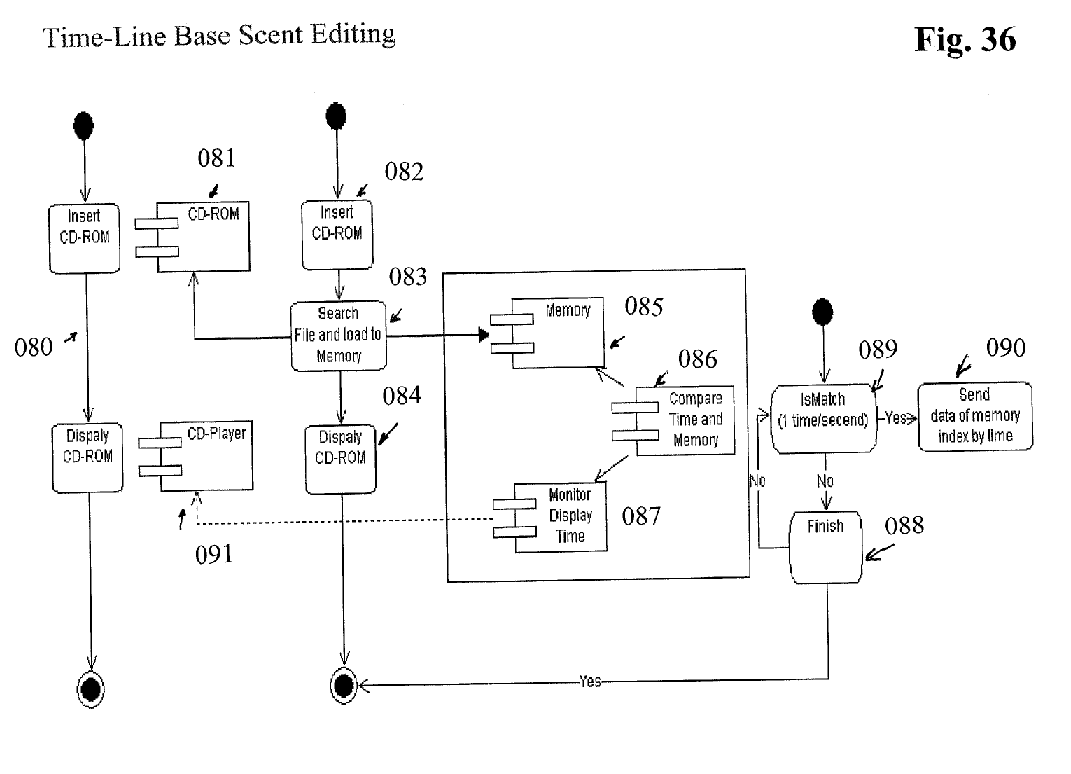

A twelfth preferred embodiment of the present invention comprises apparatus and method for permitting a user to create time-line based scent release and multimedia playback sequences. The apparatus of the twelfth embodiment comprises a scent release and multimedia playback system having a time-line editing means. FIGS. 35 and 36 depict the apparatus and method of the twelfth preferred embodiment. The time line scent release and multimedia editing means comprises a visual display and audio playback means for displaying or playing multimedia information; a timeline display means for displaying a timeline that coincides with the playback of the multimedia information; scent release addition means for adding scent release events to the multimedia timeline; and scent release and multimedia playback information recording means for recording the user-created scent release and multimedia playback timeline in a volatile or non-volatile memory medium for retrieval at a future time.

A variant of the apparatus of the twelfth embodiment is depicted in FIG. 35. Time-line based scent release and multimedia playback control information can either be created from scratch, or created by editing existing scent release and multimedia playback control information. When a user desires to create scent release and multimedia playback control information from scratch, the system first has to create a time line corresponding to the multimedia segment. A microprocessor 070 accomplishes this by recovering a video signal 072 or audio signal 073 corresponding to multimedia segments to which scent release events will be added. The microprocessor creates a time line corresponding to the multimedia segment as shown at 075. If pre-existing scent release and multimedia playback information 074 exists, the navigation means 071 of the microprocessor recovers this information from where it is stored. In the both cases, the user employs editing software 076 to either add or modify scent release events to the timeline as shown in FIG. 35. Using the editing software, a user can specify the identity of a scent to be released; the start/end time of scent release; and the strength of scent release. Since it is time-lined based, the user will have precise control over scent release events so that they coincide with the desired portion of a multimedia segment.

The method of the twelfth embodiment comprises the following steps: creating a timeline corresponding to a multimedia playback sequence; adding scent release events to the timeline, wherein the scent release event information comprises scent identity; scent release start time; and scent release end time; and saving the scent release and multimedia playback timeline in a memory medium for future retrieval in controlling a scent release and multimedia playback sequence. A variant of the method of the twelfth embodiment includes the additional step of adding multiple overlapping scent release events to the scent release and multimedia playback timeline.

Another variant of the twelfth embodiment is depicted in FIG. 36. The user selects a CD-ROM having the desired multimedia segment at step 081 and inserts the CD-ROM into a scent release and multimedia playback system having time line editing means at step 082. The user then selects the desired multimedia segment, for example, video segment, at step 083. During the creation of time-line based scent release and multimedia playback control information, the user can display the multimedia information at step 084 so that she can see the procession of the multimedia segment. The ability to monitor the multimedia playback to see what is playing at a particular point along the time line makes for highly accurate and precise scent release and multimedia playback sequences. The microprocessor stores the sequence in memory at step 085 so that it can be accessed during the creation of scent release and multimedia playback sequences. During scent release and multimedia playback events, the microprocessor recovers the scent release and multimedia playback control information and monitors the information as the multimedia segment is played back. At step 089, it detects a scent release event. When a scent release event is detected, the correct scent is released from the scent-bearing card. The microprocessor continues scent release until the time line indicates the completion of the scent release event at step 089. This continues for each subsequent scent release event until the end of the multimedia segment at step 088.

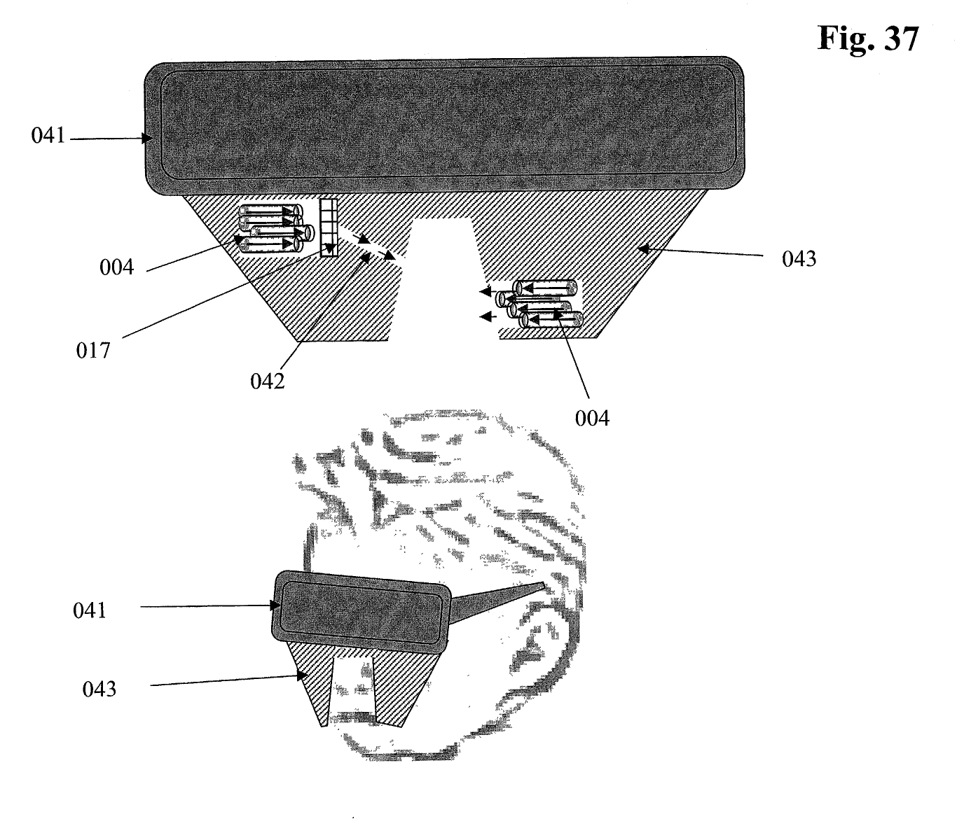

A thirteenth preferred embodiment of the present invention is depicted in FIG. 37, and comprises an electrostatic scent release mask and multimedia goggle. The electrostatic scent release mask is combined with a goggle visual monitor 041 that displays visual information intended to coincide with scent and flavor release accomplished by the electrostatic scent release mask. The mask can also include earphones to provide audio information. The mask depicted in FIG. 37 would operate under the control of, and be connected to, a separate scent release and multimedia playback system that would control the release of scent from the electrostatic scent release mask 043. The electrostatic scent release mask depicted in FIG. 20 dispenses fragrance, scent or aroma on the left side (which is directed to the nose) and dispenses flavor on the right side (which is directed to the mouth). The scent releasing units 004 on the left side of the mask operate in conjunction with a grid 017 to first ionize and then neutralize the released scent molecules. The flavor releasing units 004 on the right side of the mask do not operate in conjunction with a grid, and thus the released flavor molecules remain ionized. This permits more accurate flavor delivery to the mouth. Although the individual fragrance, scent, aroma or flavor cells are shown mounted in the mask in FIG. 20, in alternate embodiments these can be remotely located, and the scent can be transported to the user's nose or mouth though a tube.

Thus it is seen that a scent and multimedia storage cartridge design having electrostatic scent release and methods for using same are provided in the preceding embodiments of the present invention. One skilled in the art will appreciate that the present invention also provides other methods and systems, for example, an editing system for editing digital multimedia playback and scent release systems. In addition, one skilled in the art will further appreciate that the present invention can be practiced in other applications where similar features are desired. Further, one skilled in the art will appreciate that the present invention can be practiced by other than the described embodiments; that these described embodiments are presented for the purposes of illustration and not of limitation; and that the present invention is therefore limited only by the claims which follow.

1. A scent- and multimedia-bearing card for use with a separate scent release and multimedia playback system, the scent- and multimedia-bearing card comprising:
a scent storage medium for storing at least one scent;
an encapsulated multimedia storage medium for storing multimedia information; and
scent release and multimedia playback control information for use by the scent release and multimedia playback system in coordinating scent release and multimedia playback from the scent- and multimedia-bearing card.

2. The scent- and multimedia-bearing card of claim 1 wherein the encapsulated multimedia storage medium comprises a Type II DVD-RAM-like cassette device, the Type II DVD-RAM-like cassette device having a housing structure encapsulating a removable DVD-RAM or DVD disc.

3. The scent- and multimedia-bearing card of claim 1 wherein the scent storage medium stores a plurality of scents.

4. The scent- and multimedia-bearing card of claim 1 wherein the scent storage medium stores at least one fragrance.

5. The scent- and multimedia-bearing card of claim 1 wherein the scent storage medium stores at least one aroma.

6. The scent- and multimedia-bearing card of claim 1 wherein the scent storage medium stores at least one flavor.

7. The scent- and multimedia-bearing card of claim 1 wherein the scent storage medium stores at least one air-borne therapeutic agent.

8. The scent- and multimedia-bearing card of claim 1 wherein the scent storage medium stores at least one air-borne medicine.

9. The scent- and multimedia-bearing card of claim 1 wherein the scent storage medium comprises:
a housing;
a scent storage reservoir contained in the housing; and
a scent release unit connected to the scent storage reservoir for releasing scent from the scent- and multimedia-bearing card.

10. The scent- and multimedia-bearing card of claim 9 wherein the scent release unit comprises:
a scent release chamber for containing scent just prior to release; and
a tube connecting the scent reservoir to the scent chamber.

11. The scent- and multimedia-bearing card of claim 10 wherein the scent release chamber comprises a three-dimensional region enclosed on all sides except having a scent release opening facing upwards for releasing scent from the scent release chamber, and wherein the scent release unit further comprises:
a cover for covering the scent release opening, wherein the cover is moveable between at least two positions, a first position wherein the scent release opening is substantially sealed thereby preventing scent from escaping from the scent release chamber, and a second position, wherein the cover is displaced from the opening in the scent release chamber, wherein the displacement of the cover permits scent to escape from the scent release chamber during scent release operations.

12. The scent- and multimedia-bearing card of claim 11 wherein the cover is made from electromagnetic material and wherein the scent release unit further comprises:
an electromagnet for moving the cover from the first position to the second position; and
electromagnet control means for controlling the operation of the electromagnet.

13. The scent- and multimedia-bearing card of claim 12 wherein the electromagnet control means further comprises:
wiring for receiving control signals from the scent release and multimedia playback system, the control signals controlling the operation of the electromagnet.

14. The scent- and multimedia-bearing card of claim 12 further comprising:
a spring connecting the cover to the scent release unit, wherein the spring maintains the cover in the first, closed position until the electromagnet is energized, when the cover moves to the open, second position, and wherein the spring returns the cover to the closed position after the electromagnet is de-energized.

15. The scent- and multimedia-bearing card of claim 14 wherein the spring comprises a spiral spring.

16. The scent- and multimedia-bearing card of claim 12 wherein the scent release unit further comprises:
a hinge connecting the cover to the scent release unit, whereby the cover can rotate about the hinge while opening and closing; and
a leaf spring cooperating with the hinge to return the cover to a closed position when the electromagnet is not energized.

17. The scent- and multimedia-bearing card of claim 10 wherein the scent release unit further comprises an absorbent material positioned within the scent release chamber for momentarily retaining scent to be released from the scent- and multimedia-bearing card.

18. The scent- and multimedia-bearing card of claim 9 wherein the scent release unit further comprises:
electrostatic scent release apparatus for ionizing scent in the scent release unit.

19. The scent- and multimedia-bearing card of claim 18 wherein the electrostatic scent release apparatus further comprises:
corona discharge pin for creating corona discharge to ionize scent; and
wiring for connecting the corona discharge pin to an external voltage source.

20. The scent- and multimedia-bearing card of claim 19 wherein the electrostatic scent release apparatus further comprises:
a grid opposite from the corona discharge pin for attracting ionized scent molecules to assist in the scent release process.

21. The scent- and multimedia-bearing card of claim 12 wherein the scent release unit further comprises:
electrostatic scent release apparatus for ionizing scent in the scent release unit.

22. The scent- and multimedia-bearing card of claim 21 wherein the electrostatic scent release apparatus further comprises:
corona discharge pin for creating corona discharge to ionize scent; and
wiring for connecting the corona discharge pin to an external voltage source.

23. The scent- and multimedia-bearing card of claim 22 wherein the cover and electromagnet are coated in epoxy, wherein the epoxy protects the cover and electromagnet during corona discharge.

24. The scent- and multimedia-bearing card of claim 22 wherein the electrostatic scent release apparatus further comprises:
a grid opposite from the corona discharge pin for attracting ionized scent molecules to assist in the scent release process.

25. A scent-bearing card for use with encapsulated optical multimedia storage devices of the type wherein an optical disc is contained in a storage housing, the scent-bearing card and encapsulated optical multimedia storage devices for use with a separate scent release and multimedia playback system to create an immersive multimedia experience comprised of olfactory and visual or sound elements, the scent-bearing card comprising:
a scent storage medium for storing at least one scent; and
scent release control information for use by the scent release and multimedia playback system in controlling scent release from the scent-bearing card.

26. The scent- and multimedia-bearing card of claim 25 wherein the encapsulated multimedia storage optical multimedia storage device comprises a Type II DVD-RAM-like cassette device, the Type II DVD-RAM-like cassette device having a housing structure encapsulating a removable DVD-RAM or DVD disc.

27. The scent-bearing card of claim 25 wherein the scent storage medium stores a plurality of scents.

28. The scent-bearing card of claim 25 wherein the scent storage medium stores at least one fragrance.

29. The scent-bearing card of claim 25 wherein the scent storage medium stores at least one aroma.

30. The scent-bearing card of claim 25 wherein the scent storage medium stores at least one flavor.

31. The scent-bearing card of claim 25 wherein the scent storage medium stores at least one air-borne therapeutic agent.

32. The scent-bearing card of claim 25 wherein the scent storage medium stores at least one air-borne medicine.

33. The scent-bearing card of claim 33 wherein the scent storage medium comprises:
a housing;
a scent storage reservoir contained in the housing; and
a scent release unit connected to the scent storage reservoir for releasing scent from the scent-bearing card.

34. The scent-bearing card of claim 33 wherein the scent release unit comprises:
a scent release chamber for containing scent just prior to release; and
a tube connecting the scent reservoir to the scent release chamber.

35. The scent-bearing card of claim 34 wherein the scent release chamber comprises a three dimensional region enclosed on all sides except having a scent release opening facing upwards for releasing scent from the scent release chamber, and wherein the scent release unit further comprises:
a cover for covering the scent release opening, wherein the cover is moveable between at least two positions, a first position wherein the scent release opening is substantially sealed thereby preventing scent from escaping from the scent release chamber, and a second position, wherein the cover is displaced from the opening in the scent release chamber, wherein the displacement of the cover permits scent to escape from the scent release chamber during scent release operations.

36. The scent-bearing card of claim 35 wherein the cover is made from electromagnetic material and wherein the scent release unit further comprises:
an electromagnet for moving the cover from the first position to the second position; and
electromagnet control means for controlling the operation of the electromagnet.

37. The scent-bearing card of claim 36 wherein the electromagnet control means further comprises:
wiring for receiving control signals from the scent release and multimedia playback system, the control signals controlling the operation of the electromagnet.

38. The scent-bearing card of claim 36 further comprising:
a spring connecting the cover to the scent release unit, wherein the spring maintains the cover in the first, closed position until the electromagnet is energized, when the cover moves to the open, second position, and wherein the spring returns the cover to the closed position after the electromagnet is de-energized.

39. The scent-bearing card of claim 38 wherein the spring comprises a spiral spring.

40. The scent-bearing card of claim 36 wherein the scent release unit further comprises:
a hinge connecting the cover to the scent release unit, whereby the cover can rotate about the hinge while opening and closing; and
a leaf spring cooperating with the hinge to return the cover to a closed position when the electromagnet is not energized.

41. The scent-bearing card of claim 33 wherein the scent release unit further comprises an absorbent material positioned within the scent release chamber for momentarily retaining scent to be released from the scent-bearing card.

42. The scent-bearing card of claim 33 wherein the scent release unit further comprises:
electrostatic scent release apparatus for ionizing scent in the scent release unit.

43. The scent-bearing card of claim 42 wherein the electrostatic scent release apparatus further comprises:
corona discharge pin for creating corona discharge to ionize scent; and
wiring for connecting the corona discharge pin to an external voltage source.

44. The scent-bearing card of claim 43 wherein the electrostatic scent release apparatus further comprises:
a grid opposite from the corona discharge pin for attracting ionized scent molecules to assist in the scent release process.

45. The scent-bearing card of claim 36 wherein the scent release unit further comprises:
electrostatic scent release apparatus for ionizing scent in the scent release unit.

46. The scent-bearing card of claim 45 wherein the electrostatic scent release apparatus further comprises:
corona discharge pin for creating corona discharge to ionize scent; and
wiring for connecting the corona discharge pin to an external voltage source.

47. The scent-bearing card of claim 46 wherein the cover and electromagnet are coated in epoxy, wherein the epoxy protects the cover and electromagnet during corona discharge.

48. The scent-bearing card of claim 47 wherein the electrostatic scent release apparatus further comprises:
a grid opposite from the corona discharge pin for attracting ionized scent molecules to assist in the scent release process.

49. A method for releasing scent from a scent-bearing card, the scent-bearing card storing scent in a scent storage unit, the scent being released from the scent-bearing card by a scent release unit connected to the scent storage unit, the scent release unit having an opening for releasing scent, the scent release unit further comprising a cover for covering the opening in the scent release unit when scent is not being released from the scent-bearing card, the scent release unit further comprising an electrostatic scent release apparatus for assisting in scent release, wherein the electrostatic scent release apparatus comprises at least a corona discharge apparatus, the method comprising the following steps:
moving scent from the scent storage unit to the scent release unit;
opening the cover in the scent release unit to permit scent release to a region immediately adjacent to the scent release unit;
energizing the electrostatic scent release apparatus, thereby ionizing the scent molecules in the scent release unit;
allowing ionized scent to escape from the opening in the scent release unit to a region outside the scent-bearing card;
creating an air flow near the scent-bearing card to assist in the venting of the released scent to a user, thereby entraining the released scent molecules in the air flow; and
venting the scent molecules entrained in the air flow to the user.

50. The method of claim 49 wherein the electrostatic scent release unit further comprises an electrically charged grid for attracting scent ionized by the corona discharge apparatus, the method comprising the following further step:
charging the grid to attract ionized scent molecules, thereby assisting the scent release operation.

51. The method of claim 49 comprising the following further step:
releasing a scent-neutralizing substance to neutralize the previously-released scent.

52. The method of claim 51 wherein the scent-neutralizing substance comprises ozone.

53. The method of claim 51 comprising the following further step:
releasing another scent after the previously-released scent has been neutralized by the scent-neutralizing substance.

54. The method of claim 52 comprising the following further step:
releasing another scent after the previously-released scent has been neutralized by the ozone.

55. A method for using a scent- and multimedia-bearing disk having electrostatic scent release, wherein the method uses an associated scent recovery/release and multimedia playback system to release scent and recover multimedia information from the scent- and multimedia-bearing disk, and wherein the method comprises the following steps:
receiving an input command from a user to initiate scent release and multimedia playback;
recovering digital scent release and multimedia playback control information corresponding to the user input command from the scent- and multimedia-bearing portion of the disk;
initiating multimedia recovery and playback corresponding to the multimedia segment selected by the user;
interpreting the identity, time, and duration of scent release reflected in the digital scent release and multimedia playback control information; and
releasing the proper scents at the proper time and for the proper duration from the scent- and multimedia-bearing disk using electrostatic scent release.

56. The method of claim 55 wherein a plurality of scents are released simultaneously.

57. The method of claim 55 comprising the additional following step:
releasing a scent neutralizing agent following the release of a scent.

58. An electrostatic scent storage and release unit for use in scent-bearing and scent- and multimedia-bearing disks and cards, wherein the electrostatic scent release unit comprises:
a scent storage reservoir;
a scent release plenum;
a capillary tube connecting the scent storage reservoir to the scent release plenum, wherein during scent release operations scent flows from the scent storage reservoir to the scent release plenum; and
an electrostatic discharge apparatus for ionizing scent to be released.

59. The electrostatic scent scent storage and release unit of claim 58 further comprising:
a piezoelectric vibrator that vibrates the capillary tube during scent release operations to improve the flow of scent from the scent storage reservoir to the scent release plenum.

60. A method for releasing scent from an electrostatic scent storage and release unit, wherein the electrostatic scent release unit comprises a scent storage reservoir; a scent release plenum; a capillary tube connecting the scent release plenum to the scent storage reservoir; an electrostatic discharge apparatus located in the scent release plenum; and a piezoelectric vibrator, the method comprising the following steps:
opening the scent storage reservoir to permit scent to flow from the scent storage reservoir to the scent release plenum;
vibrating the piezoelectric vibrator to improve scent flow from the scent storage reservoir to the scent release plenum;
ionizing the scent in the scent release plenum using the electrostatic discharge apparatus; and
releasing scent from the scent release plenum.

61. A scent- and multimedia-bearing disk that is capable of simultaneous scent release and multimedia information recovery, wherein the scent- and multimedia-bearing disk further comprises:
a circular disk substrate having a first side and a second side, wherein the first side comprises an optical multimedia storage side and the second side comprises a scent storage side, and wherein the scent storage side further comprises:
at least one scent storage housing comprising an enclosed three-dimensional region for storing at least one scent, the scent storage housing positioned atop the disk substrate, and wherein the scent storage side of the circular disk substrate has at least two sectors, an outermost ring-like circular sector and an innermost circular sector, the scent storage housing being positioned in the outermost ring-like circular sector;
at least one electrostatic scent release unit positioned within the scent storage housing, the electrostatic scent release unit comprising an electrostatic discharge needle for ionizing scent stored within the scent storage housing;
scent release means for releasing ionized scent;
electrostatic potential supply wiring positioned within the innermost sector of the scent storage side, the wiring arrayed in a circular pattern about the center of the circular disk, and having a wiring segment extending along a radius of the circular disk, the radial wiring segment connecting the inner wiring circle to the electrostatic scent release unit; and
a static top supply unit positioned atop the innermost sector of the circular disk, the static supply module further comprising:
a cylindrical, hollow housing mounted atop the innermost sector of the circular disk;
an electrical connector positioned atop the circular top surface of the cylindrical housing for accepting electric potential;
a spring-and-metallic-ball assembly mounted within the hollow portion of the cylindrical housing, wherein the spring-and-metallic-ball assembly is connected to the electrical connector on top and contacts the inner wiring circle positioned on the surface of the inner sector of the circular disk on the bottom,
whereby the spring-and-metallic-ball assembly maintains a constant electrical contact between the electrical connector and electrostatic scent release unit as the scent- and multimedia-bearing disk rotates and top supply module remains static, thereby permitting simultaneous scent release and multimedia playback operations.

62. The scent- and multimedia-bearing disk of claim 61 wherein the scent release means comprises a semi-permeable membrane which permits ionized scent to escape.

63. The scent- and multimedia-bearing disk of claim 61 wherein the scent release means comprises a single release valve.

64. The scent- and multimedia-bearing disk of claim 61 wherein there are multiple scent storage units, electrostatic scent release units and spring-and-metallic-ball assemblies, thereby permitting the simultaneous release of multiple scents.

65. A scent- and multimedia-bearing disk that is capable of simultaneous scent release and multimedia information recovery, the scent- and multimedia-bearing disk further comprising:
optical multimedia storage means for storing multimedia information;
scent storage means for storing scent, fragrance, aroma and flavor;
electrostatic scent release means for releasing scent stored in the scent storage means; and
electric potential supply means for supplying electric potential to the electrostatic scent release means while the scent- and multimedia-bearing disk rotates, thereby permitting simultaneous multimedia recovery and scent release operations.

66. A scent- and multimedia-bearing disk comprising:
a circular disk substrate, the circular disk substrate having an outermost circular, ring-like sector, and an innermost circular sector;
an optical storage medium positioned on the innermost circular sector of the circular disk substrate, the optical storage medium for storing multimedia information; and
a scent storage region positioned in the outermost circular ring-like sector, the scent storage region comprising microencapsulated scent, wherein the microencapsulated scent is released by laser energy.

67. The scent- and multimedia-bearing disk of claim 66, wherein there are a plurality of individual ring-like scent storage regions positioned in the outermost circular ring-like sector, each for storing a separate scent.

68. A scent-bearing disk comprising:
a circular disk substrate; and
a scent storage region positioned on the circular disk substrate, the scent storage region comprising microencapsulated scent, wherein the microencapsulated scent is released by laser energy.

69. The scent-bearing disk of claim 68, wherein there are a plurality of individual ring-like scent storage regions positioned in the scent storage region, each for storing a separate scent.

70. A scent release monitoring system for use in scent release systems and scent release and multimedia playback systems, the scent release monitoring system comprising:
a scent release detection means for detecting the occurrence of a scent release event;
a scent release rate determination means for determining the rate of scent release during a scent release event;
a scent release event duration monitoring means for monitoring the duration of a scent release event; and
a scent release event information storage means for storing scent release rate and scent release duration information generated by the scent release rate determination means and scent release event duration monitoring means.

71. The scent release monitoring system of claim 70 further comprising:
a scent remaining calculation means for calculating the amount of scent remaining in a scent release system based on the beginning scent amount, scent release rate, and scent duration information stored in the scent release event information storage means.

72. The scent release monitoring system of claim 70 further comprising:
a scent release event date recording means for recording the date and time of scent release events in the scent release event information storage means.

73. The scent release monitoring system of claim 70 further comprising:
a scent depletion prediction means for predicting when the scent remaining in a scent release system will be depleted, wherein the prediction is based on the beginning scent amount, scent release rate, scent release duration, and scent date/time information stored in the scent release event information storage means.

74. A method for monitoring scent release from scent release systems and scent release and multimedia playback systems comprising the following steps:
detecting a scent release event;
determining the scent release rate during the scent release event;
determining the duration of the scent release event; and
recording the scent release event information comprising the scent release rate and scent release duration in an electronic memory for use in monitoring scent utilization.

75. The method of claim 74 comprising the additional steps of:
recording scent release event information for subsequent scent release events;
multiplying the scent release rate by the scent release duration for each scent release event to determine the scent released;
adding the scent amount released during each scent release event to determine the total amount of scent released; and
subtracting the total amount of scent released from the beginning scent amount to determine the total amount of scent remaining.

76. The method of claim 74 comprising the additional steps of:
recording the time of each scent release event;
recording scent release event information, including the time of scent release, for each subsequent scent release event;
multiplying the scent release rate by the scent release duration for each scent release event to determine the amount of scent released;
adding the scent amount released during each scent release event to determine the total amount of scent released;
calculating the time span from the first scent release event to the last scent release event;
dividing the total amount of scent released by the time duration to determine a scent utilization rate;
subtracting the total amount of scent released from the beginning scent amount to determine the total amount of scent remaining; and
dividing the total amount of scent remaining by the scent utilization rate to calculate the estimated time left before the remaining scent is exhausted.

77. An editing apparatus for creating digital scent release and multimedia playback control information for use by a scent recovery/release and multimedia playback system to control scent recovery and multimedia playback operations, the editing apparatus comprising:
multimedia segment selection means for permitting a user to select a multimedia segment for use with scent release events;
timeline creation means for creating an electronic timeline corresponding to the duration of the multimedia segment; and
scent release event addition means for permitting a user to add a scent release event to the electronic timeline, whereby the addition of scent release event information to the electronic timeline creates the digital scent release and multimedia playback control information;
a memory medium for use in storing the digital scent release and multimedia playback control information created by the user; and
recording means for transferring the digital scent release and multimedia playback control information to the memory medium where it can be retrieved at a future time for use in controlling scent release and multimedia playback operations.

78. The editing apparatus of claim 77 wherein the scent release event addition means permits the user to add multiple scent release events.

79. The editing apparatus of claim 77 wherein the scent release event addition means permits the user to specify the identity of the scent to be released.

80. The editing apparatus of claim 77 wherein the scent release event addition means permits the user to specify the duration of scent release.

81. The editing apparatus of claim 77 wherein the scent release event addition means permits the user to specify the start time for scent release.

82. The editing apparatus of claim 77 wherein the scent release event addition means permits the user to specify the end time for ending a scent release event.

83. The editing apparatus of claim 77 wherein the scent release event addition means permits the user to specify the rate of scent release during the scent release event.

84. A method for creating digital scent release and multimedia playback control information for use by a scent recovery/release and multimedia playback system in controlling simultaneous scent release and multimedia playback operations, the method using an electronic editing system for creating the digital scent release and multimedia playback control information, the method comprising the following steps:
selecting a multimedia segment that will be played back in conjunction with scent release events;
creating an electronic timeline corresponding to the multimedia playback sequence;
adding at least one scent release event to the timeline, thereby creating the digital scent release and multimedia playback control information; and
saving the digital scent release and multimedia playback control information in a memory medium for future retrieval in controlling a scent release and multimedia playback sequence.

85. The method of claim 84 wherein during the adding a scent release event step the user specifies the identity of the fragrance, scent, aroma or flavor to be released.

86. The method of claim 84 wherein during the adding a scent release event step the user specifies the start time of the scent release event.

87. The method of claim 84 wherein during the adding a scent release event step the user specifies the end time for the scent release event.

88. The method of claim 84 wherein during the adding a scent release event step the user specifies the scent release rate to be applied during the scent release event.

89. The method of claim 84 comprising the additional step of:
adding multiple scent release events to the electronic timeline.

90. A multimedia playback goggle and electrostatic scent release mask for releasing scent directly to the nose and/or mouth of a user, the multimedia playback goggle and electrostatic scent release mask further comprising:
a nose-bridge-mounted display screen placed directly in front of the eyes of the user to display multimedia information;
ear phones to play back auditory information;
an electrostatic scent release mask, the electrostatic scent release mask further comprising:
a mask housing that comfortably fits over the nose and mouth of a user;
at least one scent storage unit; and
at least one electrostatic scent release unit.

91. The multimedia playback goggle and electrostatic scent release mask of claim 90, wherein the at least one scent storage unit and at least one electrostatic scent release unit are positioned adjacent to the nose to release scent directly to the nose of the user.

92. The multimedia playback goggle and electrostatic scent release mask of claim 91, wherein the electrostatic scent release means further comprises:
an electrostatic discharge needle for ionizing scent to be released from the at least one scent storage means;
a source of electric potential to supply electricity to the electrostatic discharge needle; and
wiring connecting the electrostatic discharge needle and the source of electric potential.

93. The multimedia playback goggle and electrostatic scent release mask of claim 92, wherein the electrostatic scent release means further comprises:
an electrostatic grid to attract scent molecules ionized by the electrostatic discharge needle.

94. The multimedia playback goggle and electrostatic scent release mask of claim 92, wherein the electrostatic scent release means further comprises:
a fan and ducting to create an air flow in the vicinity of the electrostatic discharge needle to assist in entraining scent ionized by the electrostatic discharge needle.

95. The multimedia playback goggle and electrostatic scent release mask of claim 90, wherein the at least one scent storage unit and at least one electrostatic scent release unit are positioned adjacent to the mouth to release flavor directly to the mouth of the user.

96. The multimedia playback goggle and electrostatic scent release mask of claim 95, wherein the electrostatic scent release means further comprises:
an electrostatic discharge needle for ionizing scent to be released from the at least one scent storage means;
a source of electric potential to supply electricity to the electrostatic discharge needle; and
wiring connecting the electrostatic discharge needle and the source of electric potential.

97. The multimedia playback goggle and electrostatic scent release mask of claim 96, wherein the electrostatic scent release means further comprises:
an electrostatic grid to attract scent molecules ionized by the electrostatic discharge needle.

98. The multimedia playback goggle and electrostatic scent release mask of claim 97, wherein the electrostatic scent release means further comprises:
a fan and ducting to create an air flow in the vicinity of the electrostatic discharge needle to assist in entraining scent ionized by the electrostatic discharge needle.
